(19) United States
(12) Patent Application Publication
(10) Pub. No.: US 2013/0211938 A1
(43) Pub. Date: Aug. 15, 2013

(54) RETAIL KIOSKS WITH MULTI-MODAL INTERACTIVE SURFACE

(71) Applicant: Aamir Ayub Allaqaband, Bellvue, WA (US)

(72) Inventor: Aamir Ayub Allaqaband, Bellvue, WA (US)

(73) Assignee: MICROSOFT CORPORATION, Redmond, WA (US)

(21) Appl. No.: 13/372,523

(22) Filed: Feb. 14, 2012

(51) Int. Cl. G06Q 20/18

(52) U.S. Cl. 705/21

(57) ABSTRACT

A multi-modal interactive surface is connected to a retail management system in a retail store. A user interface component provides user interface displays that allow a user to research products in the retail store and complete a sales transaction.

### BACKGROUND

Retail shopping has conventionally taken two different forms. The first is to shop, in-person, at a retail store. The second is to shop on-line.

Both types of shopping have advantages and disadvantages. For instance, shopping in-person in a retail store allows the shopper to browse for products, and to examine the products, physically, when comparing them. However, in-person shopping makes it difficult for the shopper to perform any type of detailed research on a product, while shopping, and also involves a fairly tedious checkout process.

On-line shopping addresses some of these problems. A user can easily research products on-line, while shopping on-line. Similarly, on-line shopping does not involve the tedious and time consuming checkout process that is required at a retail store. However, the shopper, when on-line shopping, is not able to physically examine the products, and compare them to one another.

Some retail stores publish smart phone applications to enhance in-store shopping. However, the benefits of these applications are limited to owners of the relatively expensive smart phones with data plans. Also, these applications are constrained, at least somewhat, because of the small screen sizes of the smart phones, which makes the user experience less satisfying. Similarly, these applications can be somewhat ineffective due to limited signal strength inside retail stores.

Some retail stores also have self checkout lanes. However, the devices used at those self checkout lanes are quite limited. They are sometimes limited to a barcode scanner for scanning barcodes associated with products to be purchased, along with a touch screen that allows the user to look up certain products for which no barcode can be located. Also, self checkout lanes are not commonly available to users prior to the checkout process. Therefore, they do not provide any significant advantage in terms of product browsing.

Some retail stores have also used multi-modal interactive surfaces. However, they are primarily employed for purposes of entertainment and product browsing only. They are not used to enable a retail shopper to complete a sales transaction.

The discussion above is merely provided for general background information and is not intended to be used as an aid in determining the scope of the claimed subject matter.

### SUMMARY

A multi-modal interactive surface is connected to a retail management system in a retail store. A user interface component provides user interface displays that allow a user to research products in the retail store and complete a sales transaction.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the background.

### BRIEF DESCRIPTION OF THE DRAWINGS

FIG. 1 is a block diagram of one illustrative retail system,

FIG. 2 is a flow diagram illustrating one embodiment of the operation of the retail system shown in FIG. 1.

FIGS. 2A-2D illustrate user interface displays,

FIGS. 3A-3G are illustrative embodiments of user interface displays.

FIG. 4 is a block diagram of one embodiment of the system shown in FIG. 1 in a cloud computing environment.

FIGS. 5 and 5A are block diagrams of other embodiments of the system shown in FIG. 1 in other cloud computing environments.

FIGS. 6-8 show illustrative mobile devices,

FIG. 9 is a block diagram of one illustrative computing environment.

### DETAILED DESCRIPTION

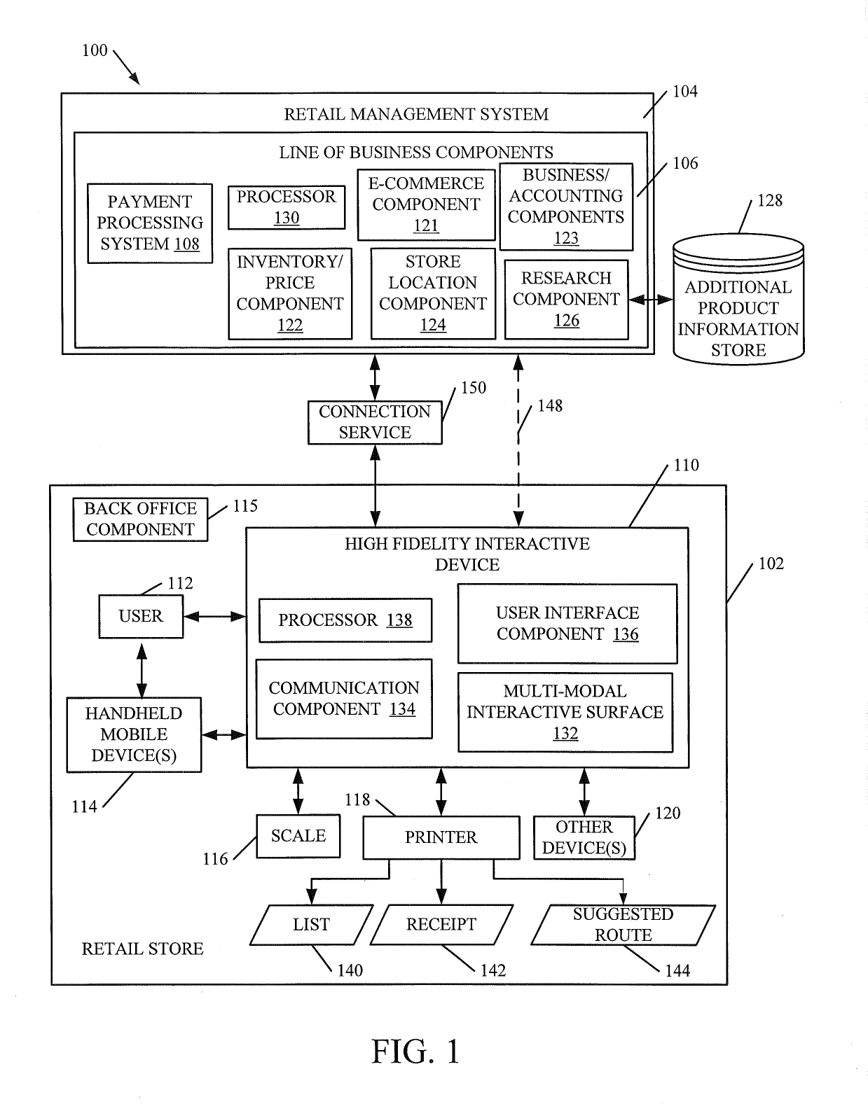

FIG. 1 is a block diagram of one embodiment of a retail system 100 that includes retail store 102 having a retail management system 104 that includes line of business components 106. Retail management system 104 is also shown with payment processing system 108 that facilitates payment processing for payments made in retail store 102. System 108 can illustratively be connected to an external payment institution such as a bank, credit card company or other payment processing facility. In the embodiment shown in FIG. 1, retail store 102 illustratively includes high fidelity interactive device 110 that is accessible by user 112, or by a handheld mobile device 114 of a user, such as a smart phone, a cellular telephone, a tablet computer or other mobile device. FIG. 1 also shows that high fidelity interactive device 110 can be connected to a variety of additional devices, such as a scale 116, printer 118, or other devices indicated by 120. As will be described in greater detail below, user 112 illustratively accesses high fidelity interactive device 110 in order to complete a sales transaction. Device 110 is illustratively connected to retail management system 104 so that the line of business components 106 can be updated based on the sales transaction completed by user 112 using device 110.

FIG. 1 also shows that retail store 102 can have back office component 115. Component 115 can act as an intermediate component between device 110 and retail management system 104. When component 115 acts as an intermediate component, it can aggregate information from device 110 (such as by caching it) or retail management system 104 (or both) and intermittently transmit the information between device 110 and system 104, or it can pass the information along directly, or it can support off-line capability in cases where the connection to system 104 is temporarily unavailable. These are given as examples of how back office component 115 can be used.

In the embodiment shown in FIG. 1, line of business components 106 are illustratively business related applications that are used to manage the retail activities of store 102. Therefore, in one embodiment, components 106 illustratively include inventory/price component 122 that manages the inventory and price control of items sold in store 102. Components 106 also illustratively include store location component 124 that can be used to provide an output to user 112 indicating where the products just purchased by user 112 can be located within store 102. Similarly, research component 126 can have access to not only product information stored in its own memory but to additional product information stored in additional product information store 128 so that user 112 can perform research on various products in store 102, prior to purchasing them. Components 106 also illustratively include processor 130 that can comprise a computer processor with associated memory and timing circuitry (not shown). Processor 130 is illustratively a functional component of system 100 and is activated by various components thereof to facilitate the functions performed by those components.

It will also be noted that retail management system 104 cart reside in a number of different places. It can be hosted on-premises, for instance, at an organization's own data center. It can also be hosted at the organization's headquarters location, or by the back office component 115 of store 102, or it can even be hosted by a third party hosting provider.

FIG. 1 also shows that high fidelity interactive device 110 illustratively includes multi-modal interactive surface 132, communication component 134, user interface component 136 and processor 138. In the embodiment shown in FIG. 1, multi-modal interactive surface 132 is illustratively a multi-touch surface with additional components that not only allow surface 132 to detect when and where it is being contacted, but to also employ vision-based components so that surface 132 can perform vision-based functions. For instance, in one embodiment, surface 132 includes vision-based components that allow surface 132 to read a barcode, read text on a wrapper, numbers on a numerical tag or other alphanumeric or coded items placed on surface 132. Similarly, in one embodiment, surface 132 employs RFID readers to read MD tags placed on or near surface 132. Surface 132 can also employ capacitive touch screen components which sense user gestures on surface 132 through capacitive sensing. Any other or different sensors can be used to accommodate multi-modal interaction with user 112 as well, and those listed are given by way of example only. Some of those kinds of sensors can include ambient light sensors, pressure sensors, an integrated scale (which can appear when an item is placed on surface 132) enhanced visual sensors and tracking systems that recognize visual gestures, enable video chat with others (such as store associates or customer service personnel), etc. Sensors that enable natural user interfaces (NUI) can be used as well. In one specific embodiment, and for purposes of example only, multi-modal high fidelity interactive device 110 is illustratively embodied using a Microsoft® Surface® device. However, this is given by way of example only and other devices can be used as well.

Communication component 134 illustratively provides one or more different types of communication with user 112. For instance, communication component 134 illustratively provides wireless communication with handheld mobile devices 114. As discussed above, handheld mobile devices 114 may include, for instance, a cellular phone, a smart phone, a personal digital assistant, a palmtop computer, a tablet computer, etc. Thus, when desired by the user, device 110 can communicate with user 112 through the user's handheld mobile device 114. In addition, device 110 can communicate with user 112 both through multi-modal interactive surface 132 and through the user's handheld mobile device 114, or in other ways as well.

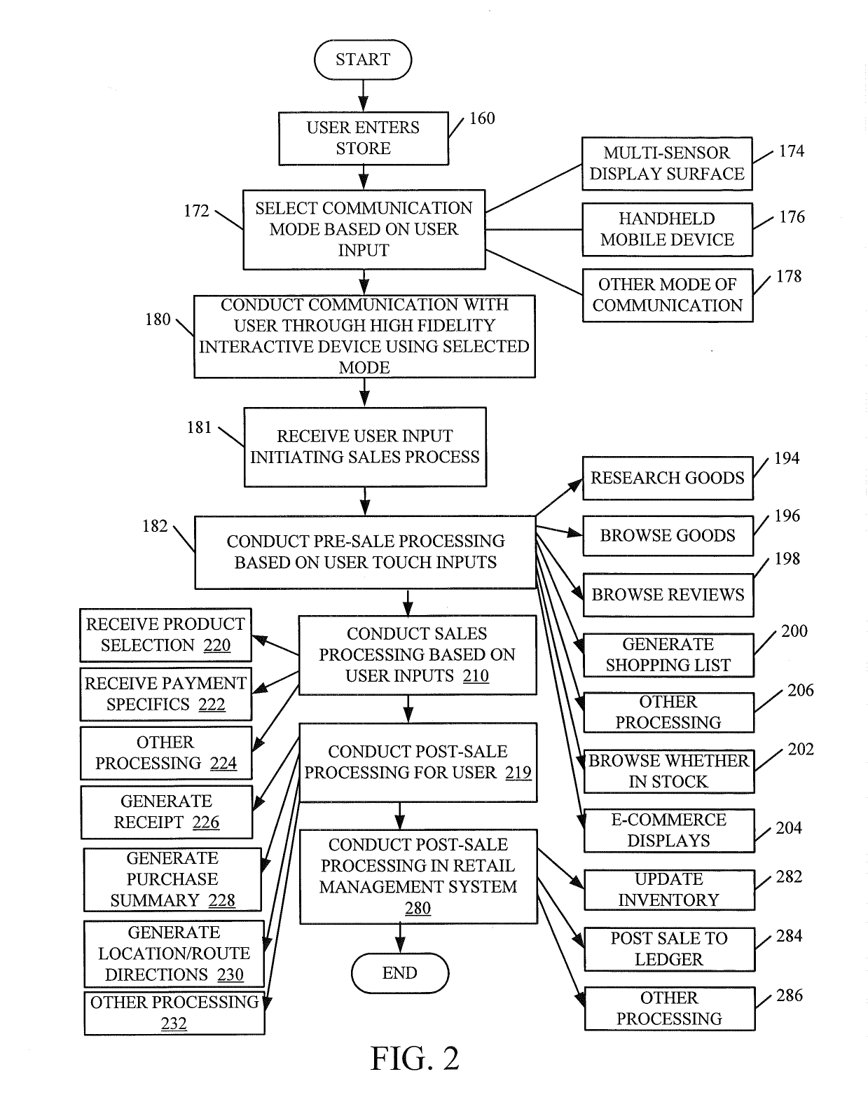

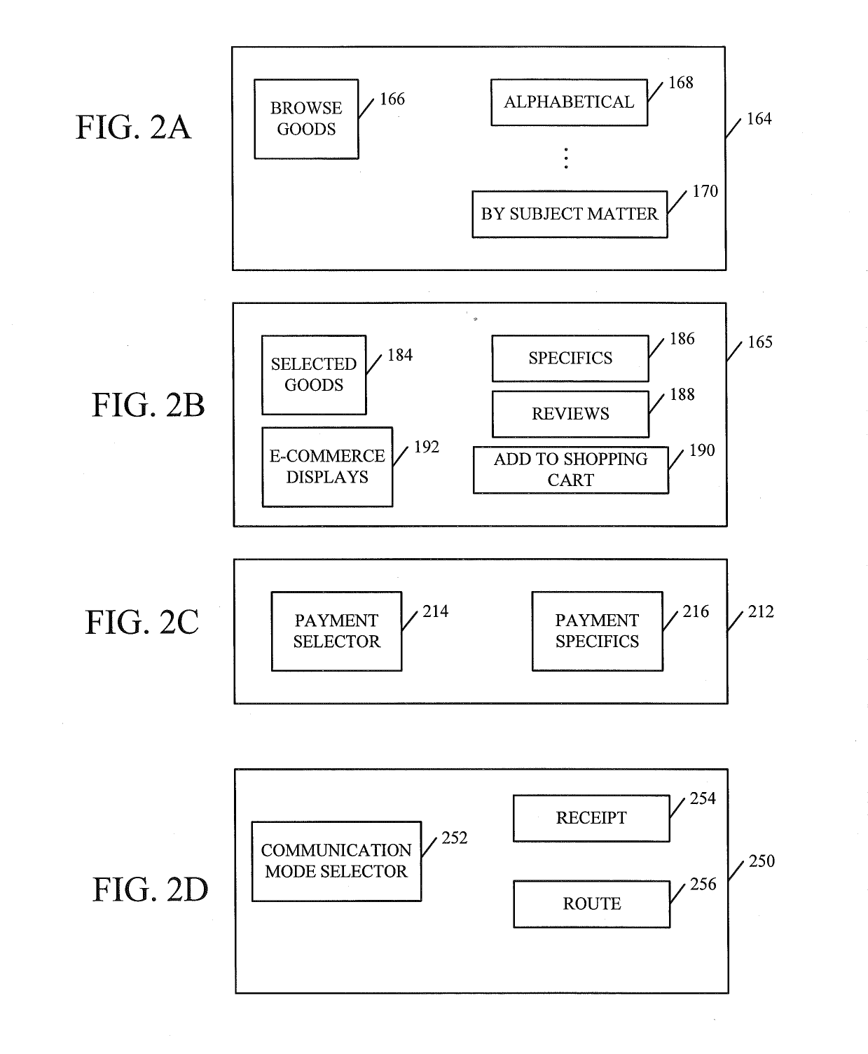

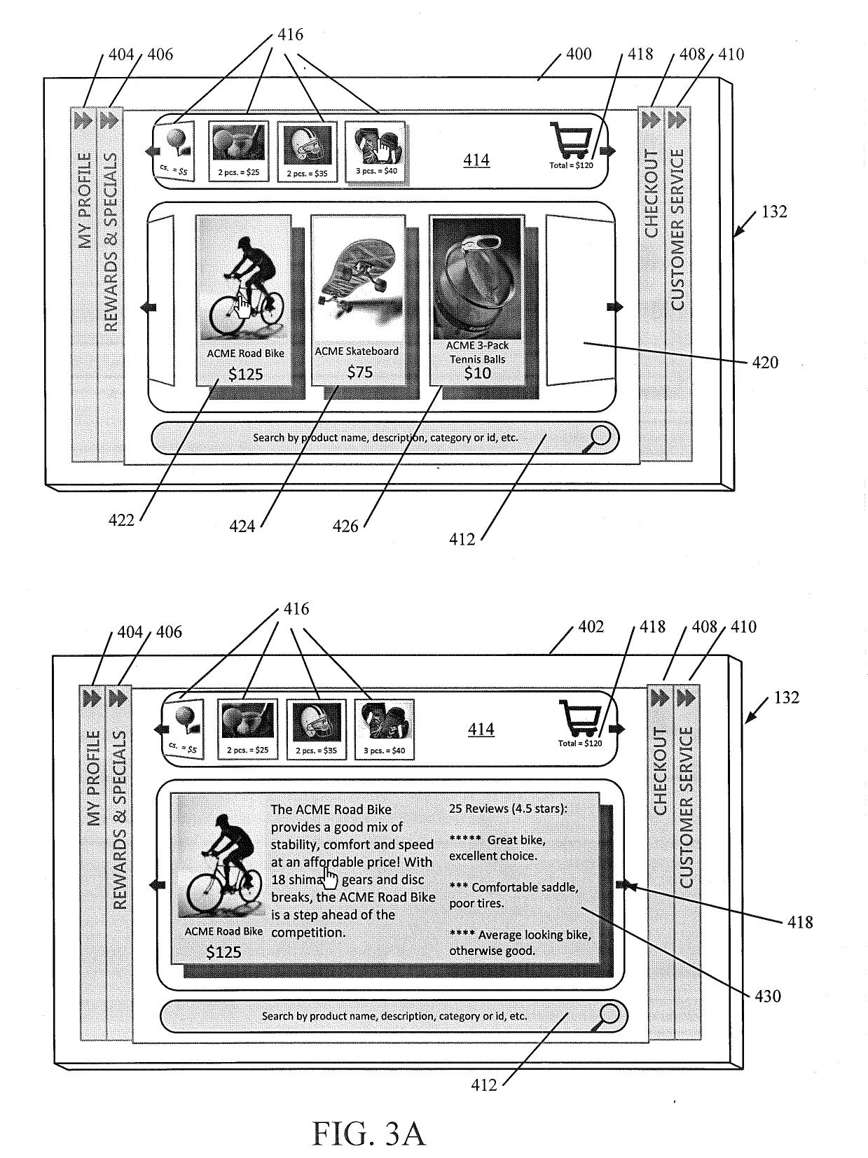

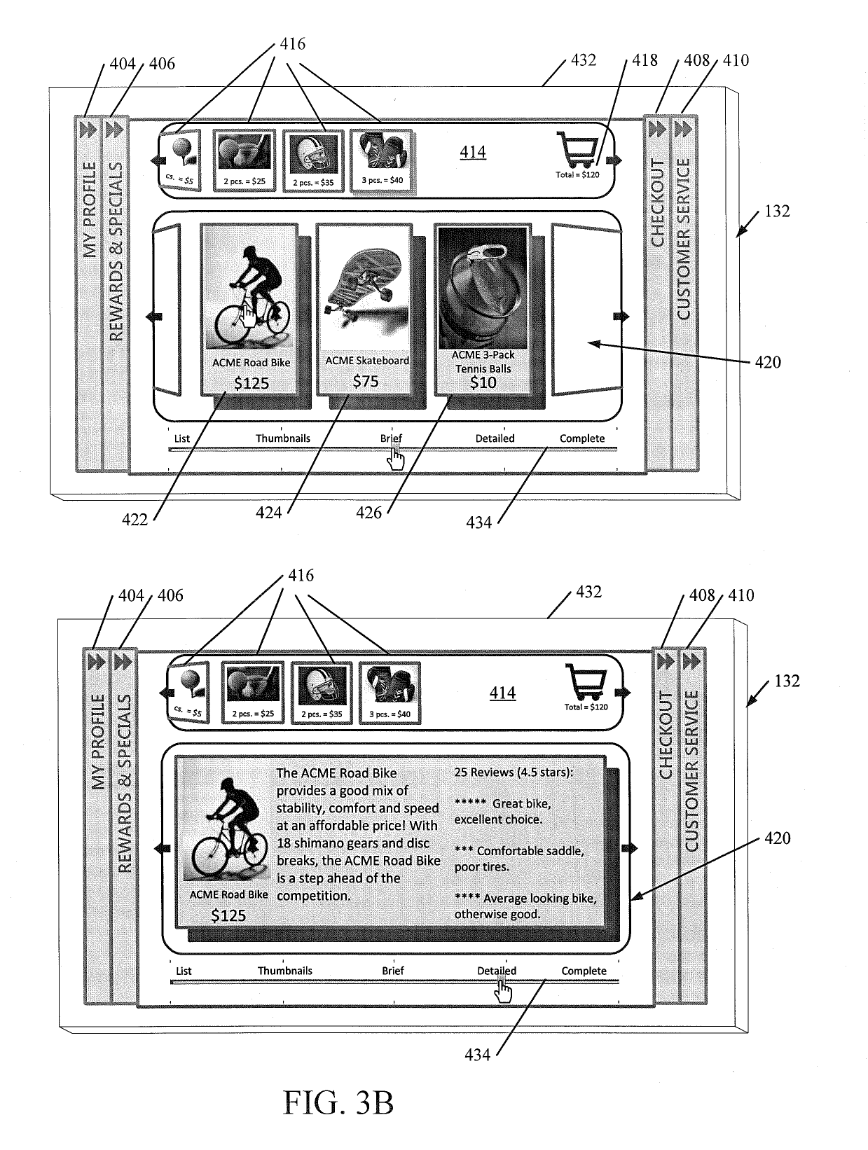

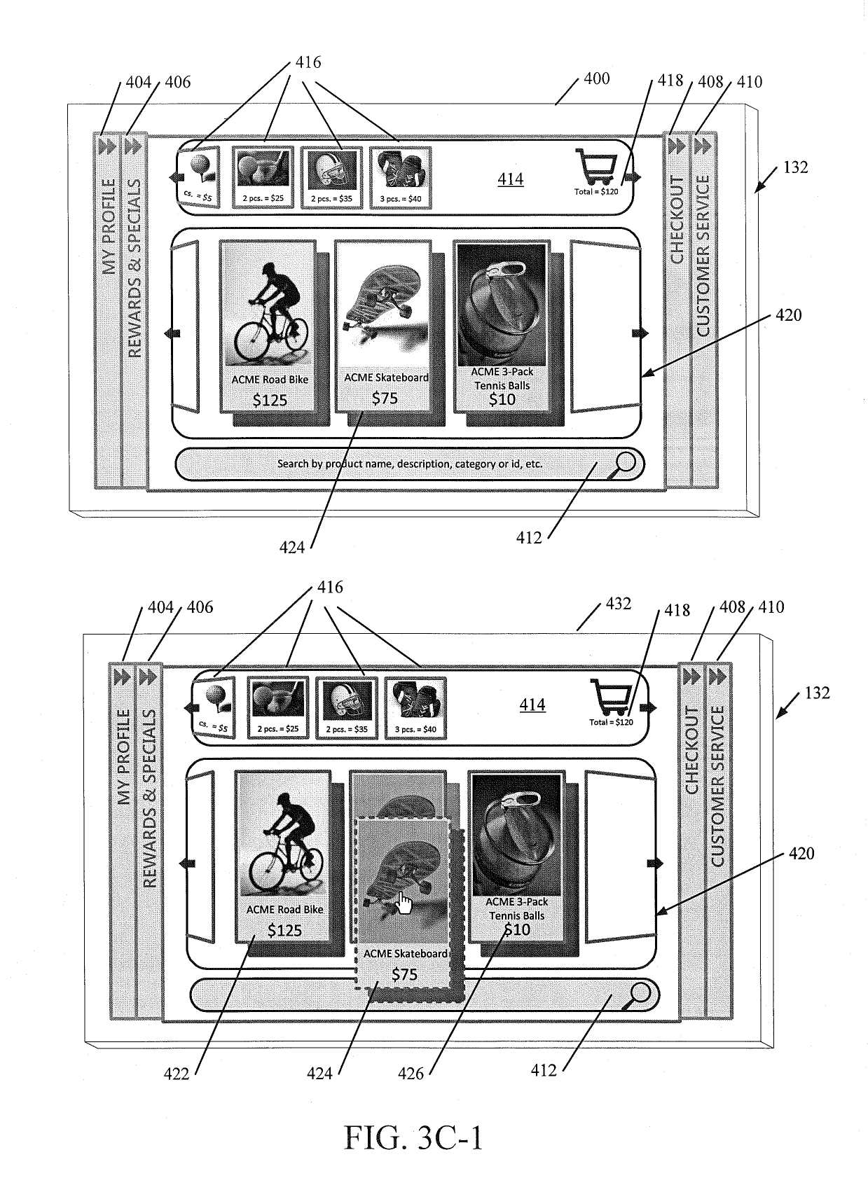

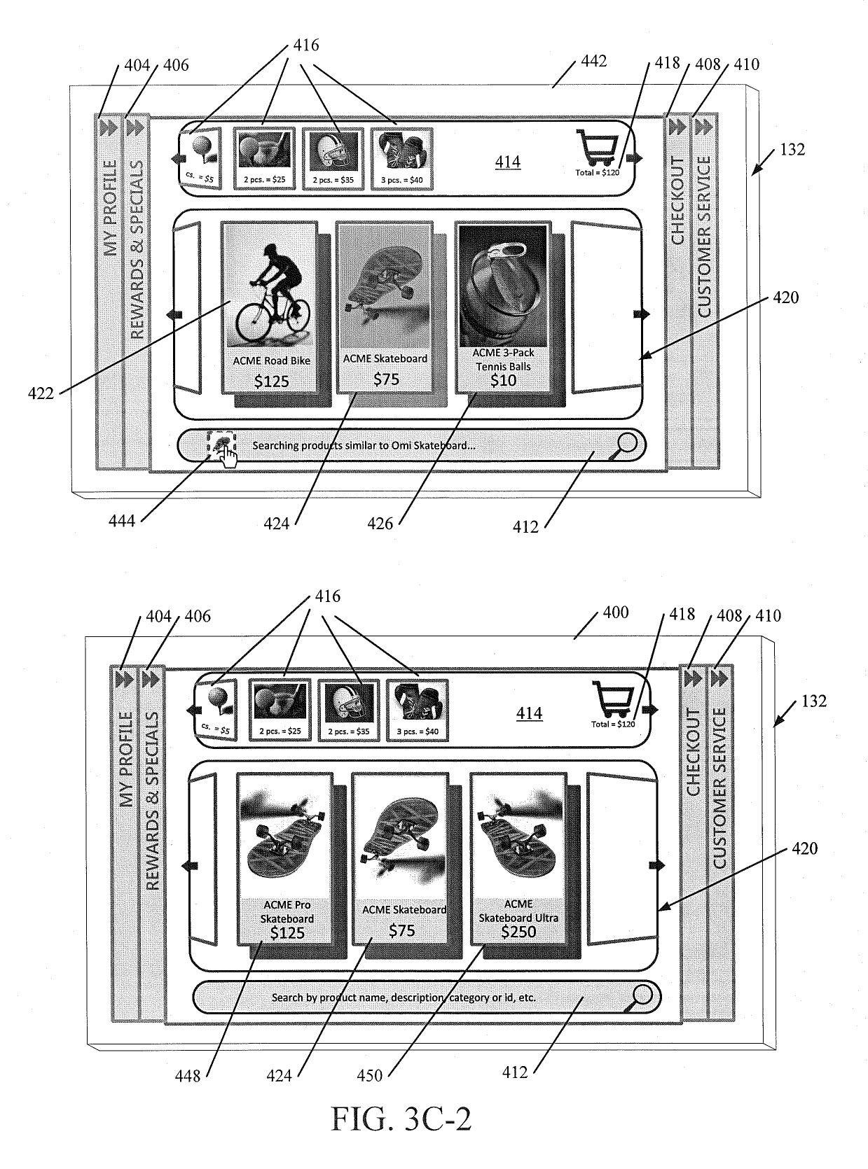

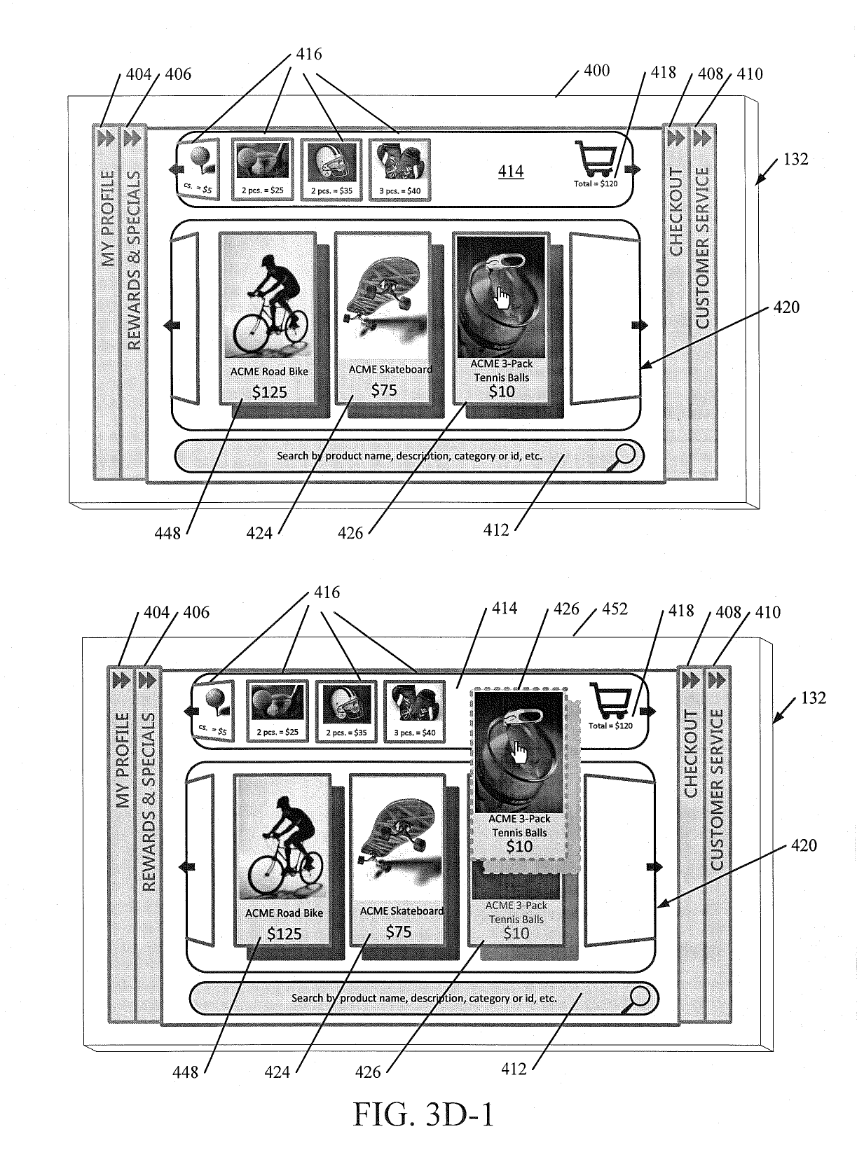

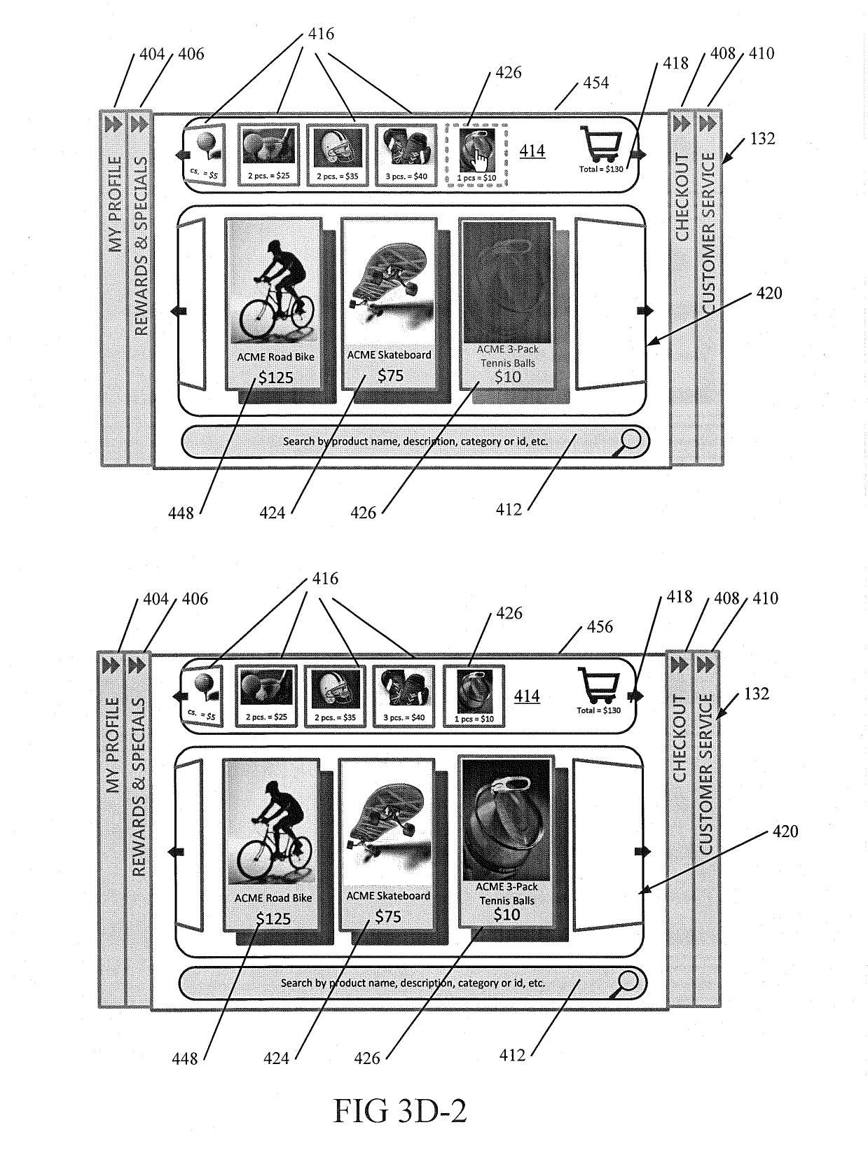

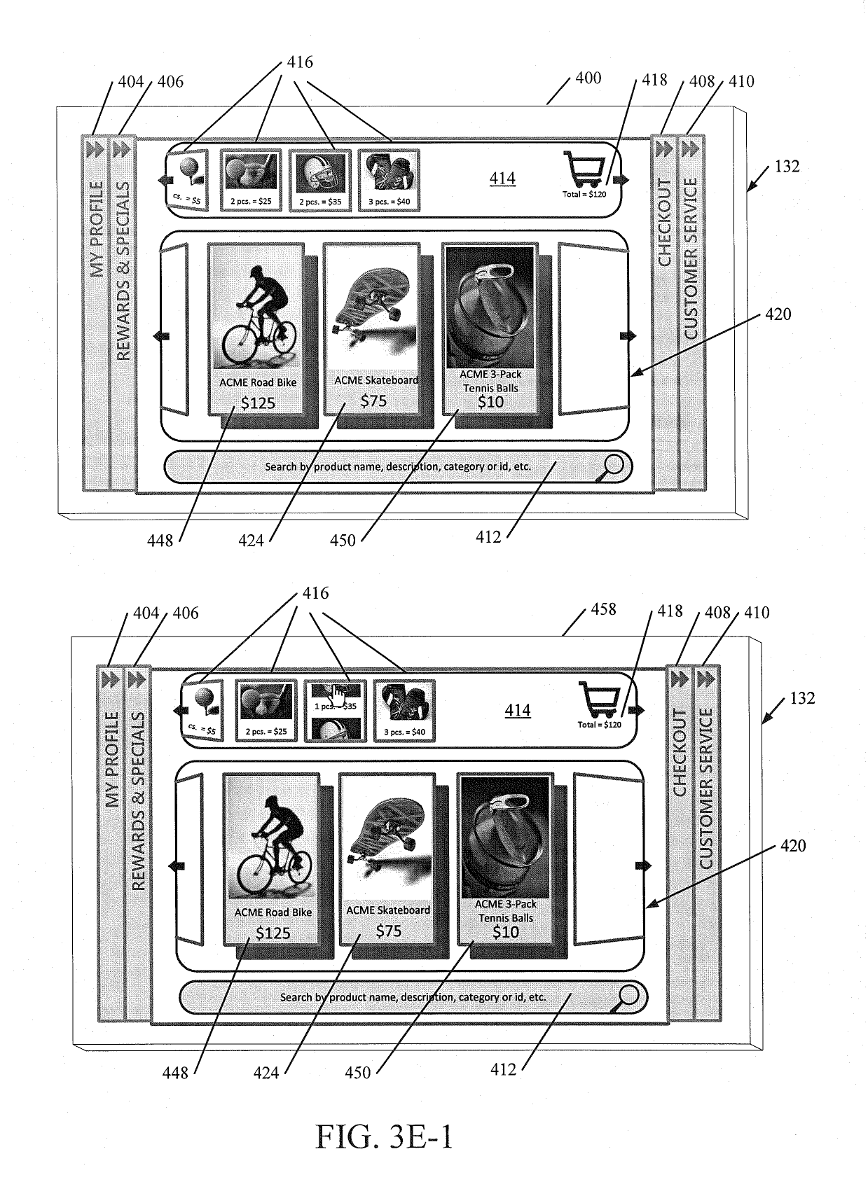

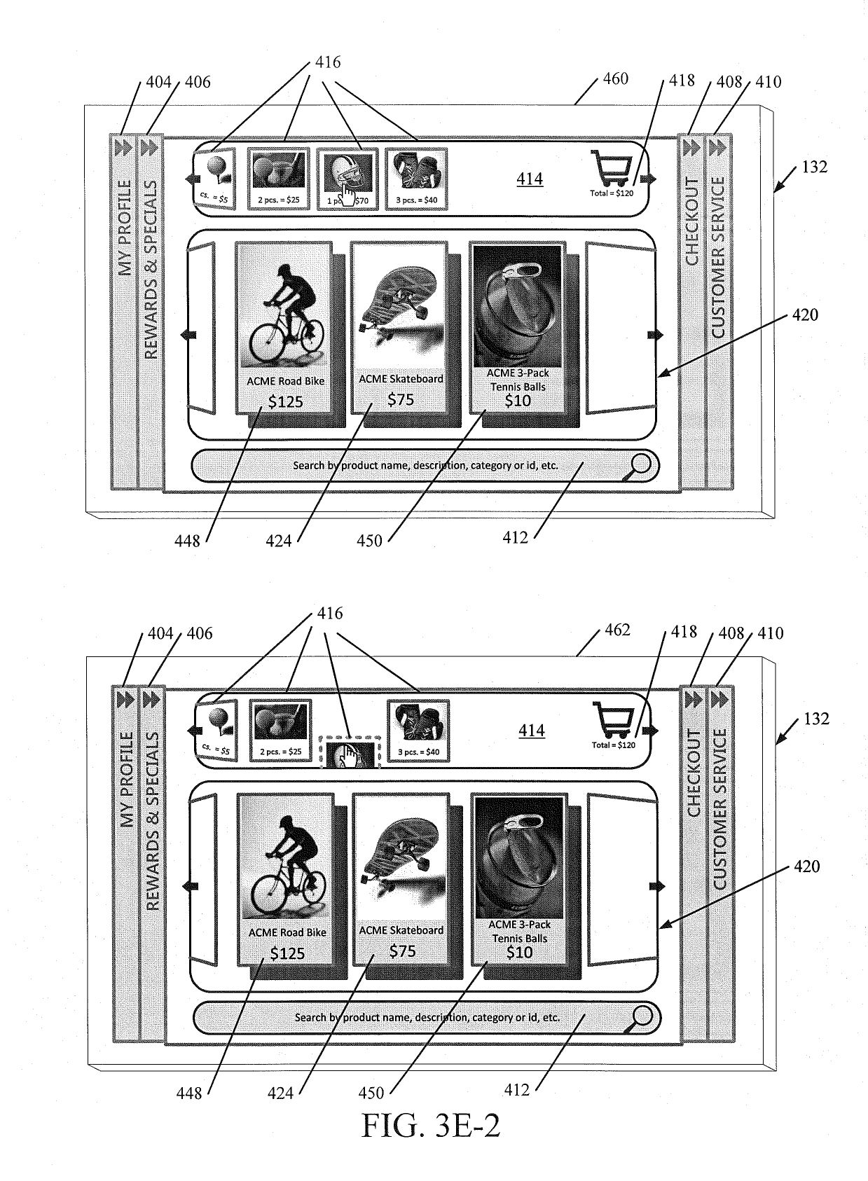

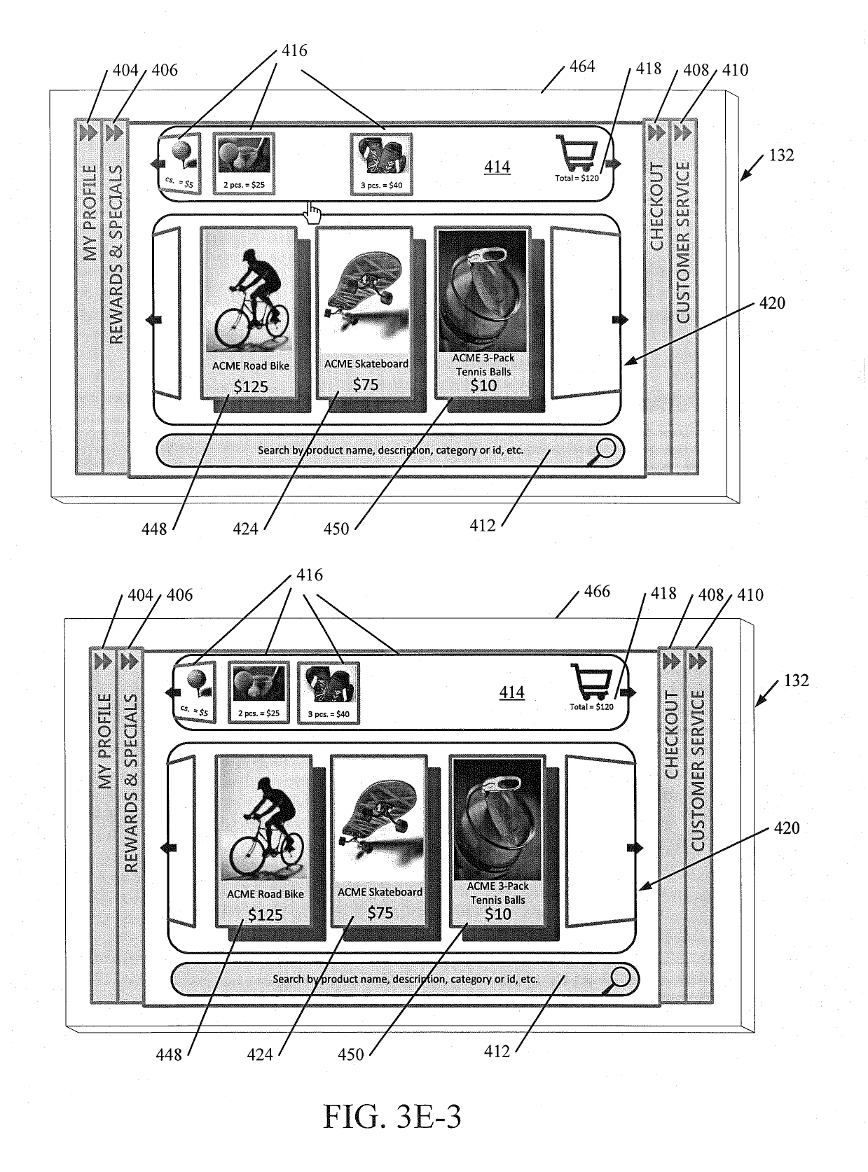

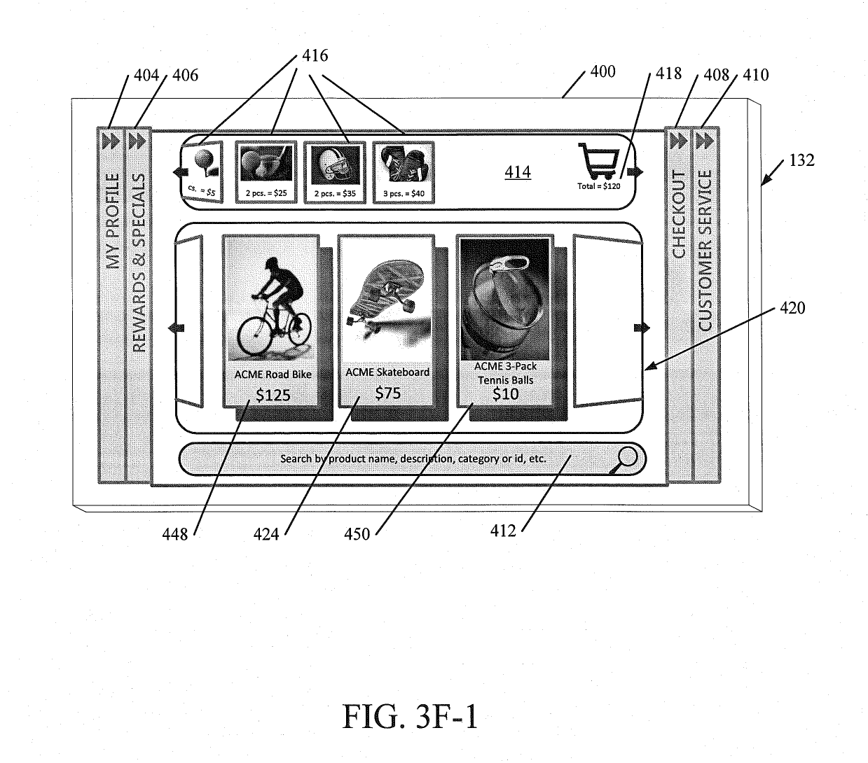

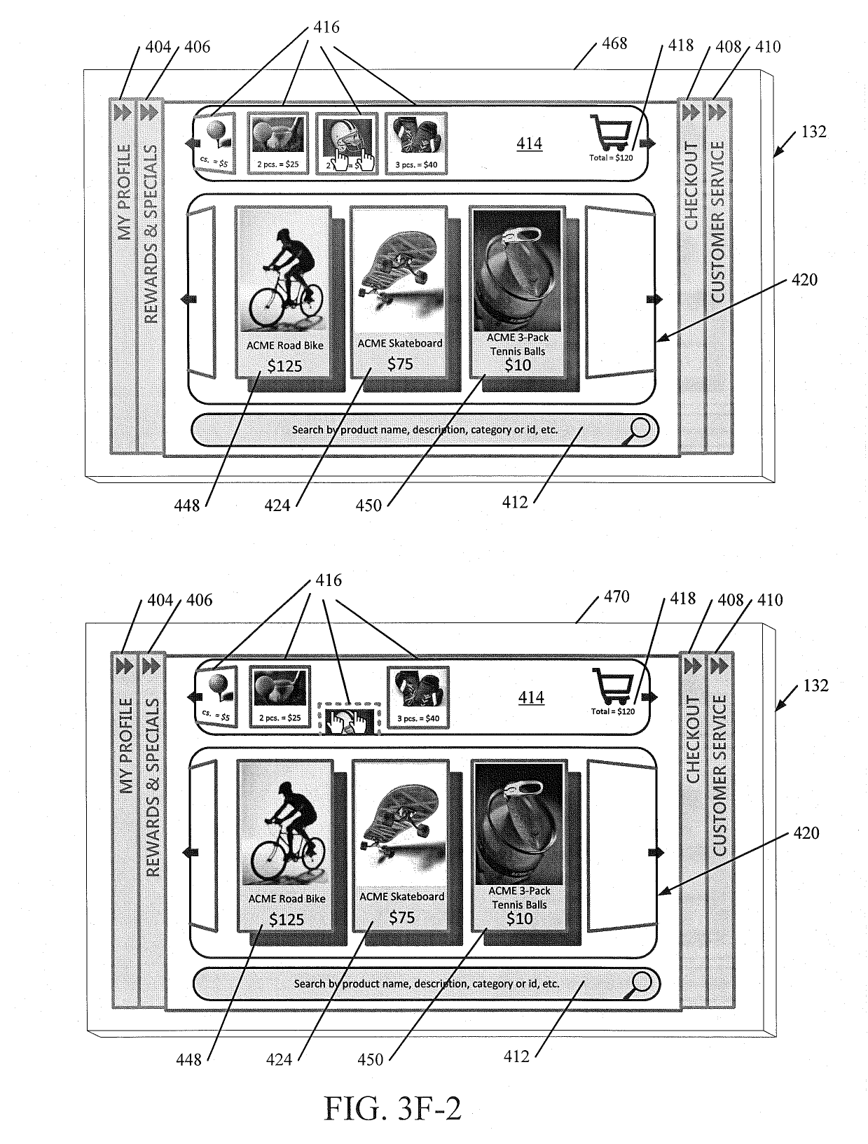

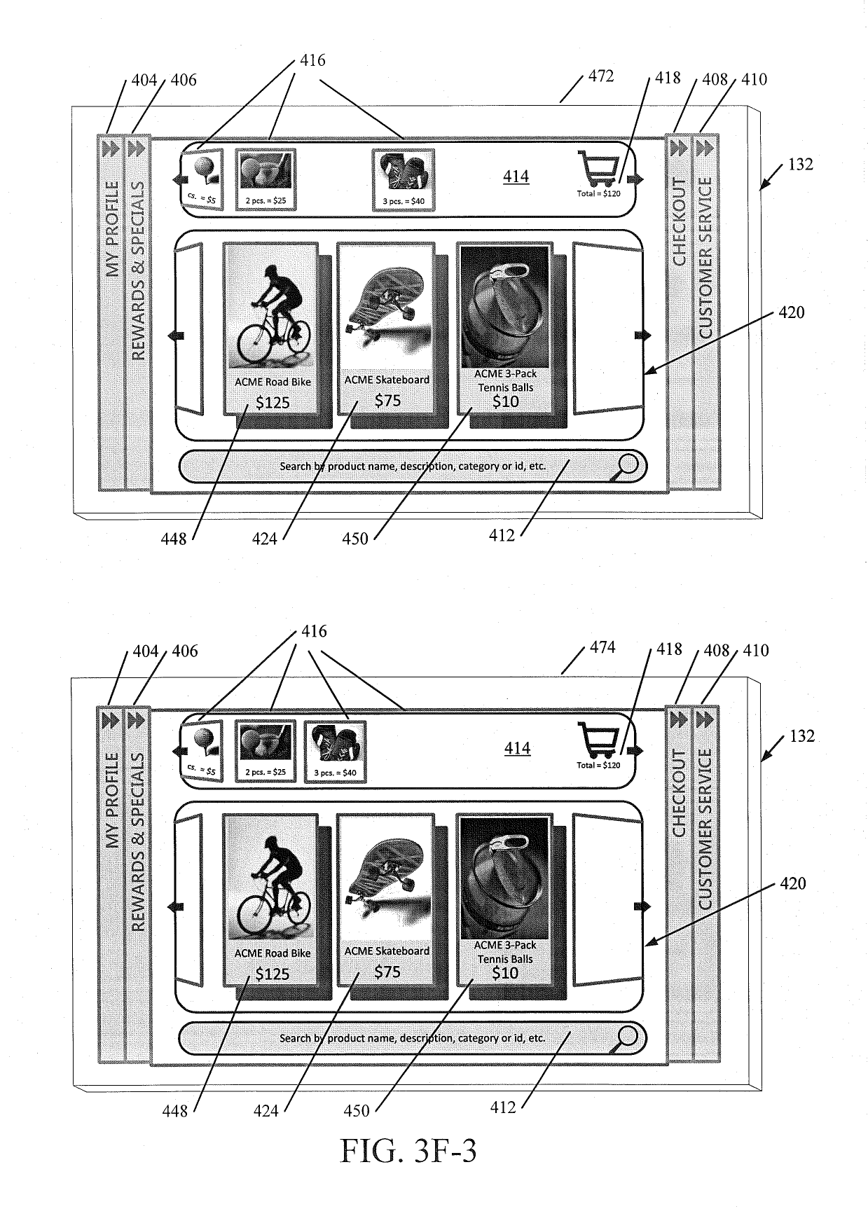

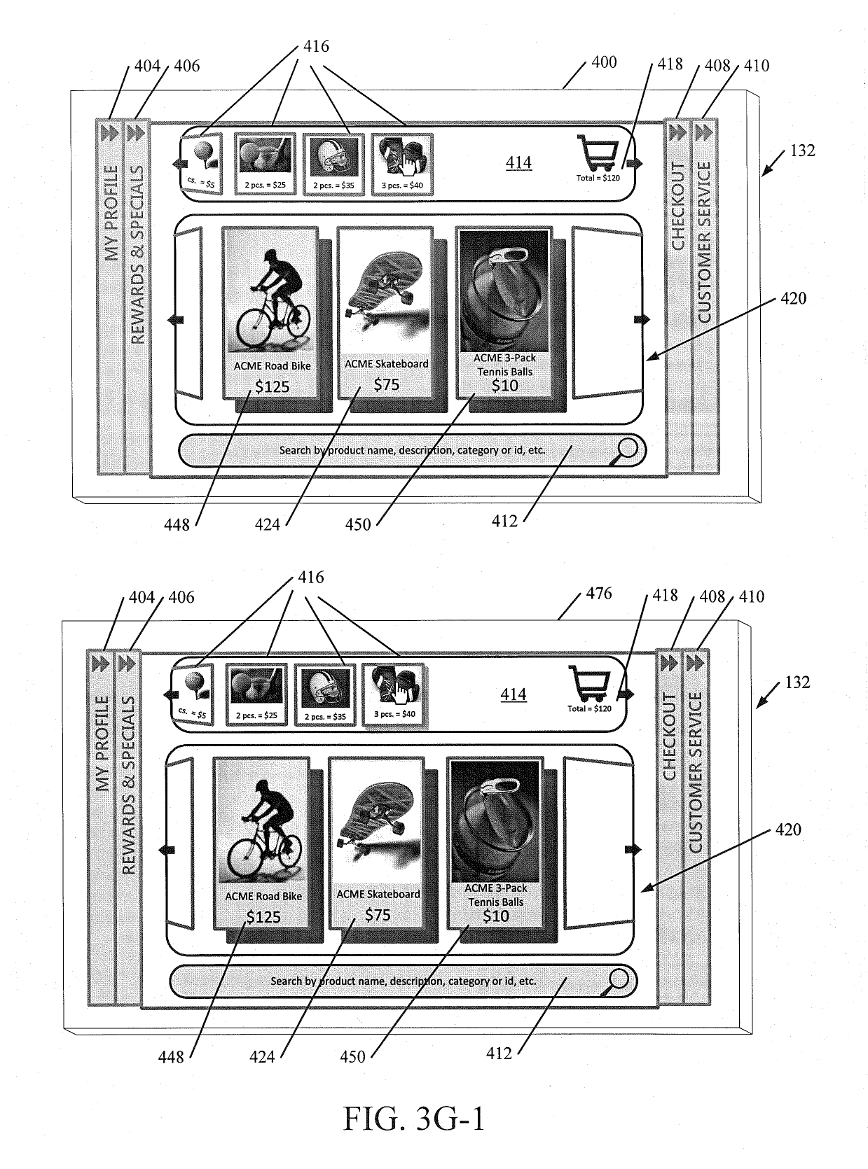

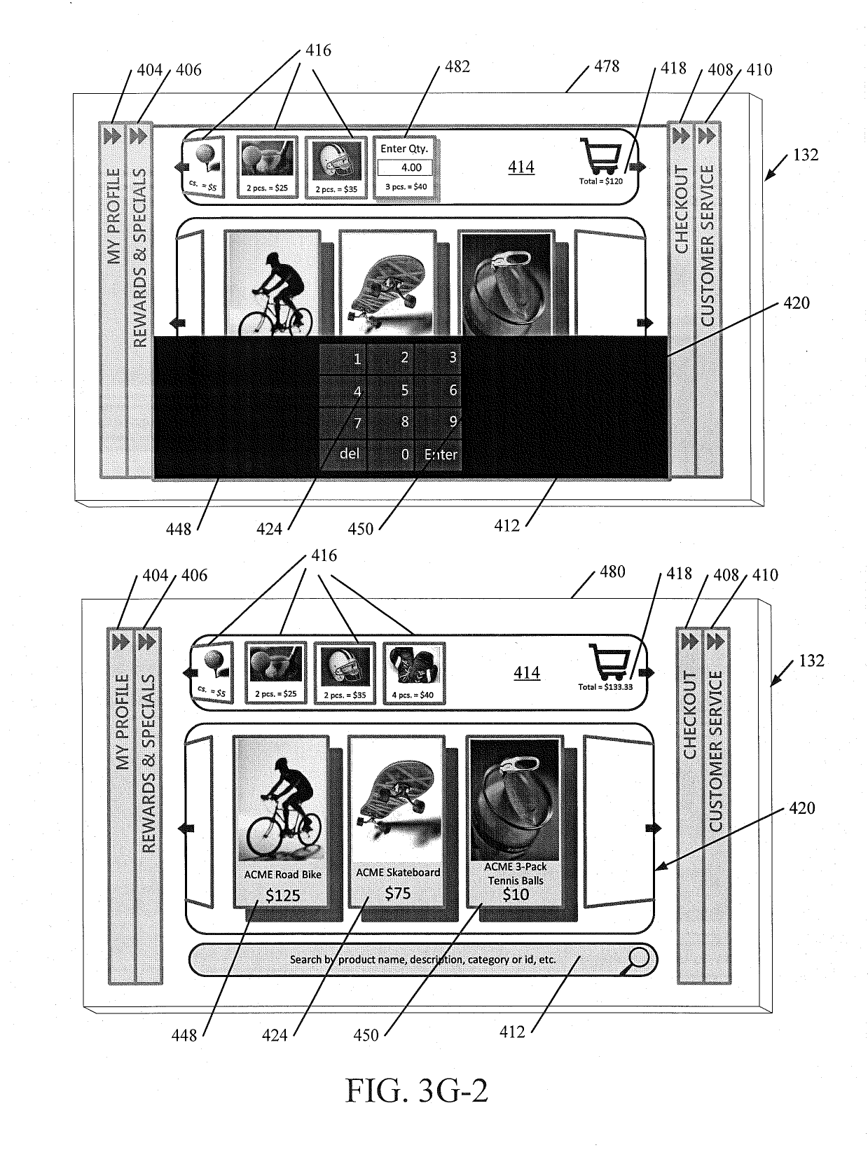

In one embodiment, user interface component 136 illustratively generates user interface displays on surface 132, with user input mechanisms that allow user 112 to communicate with device 110, through surface 132. Some examples of user interface displays that can be generated by component 136 are described in greater detail below with respect to FIGS. 2A-3G.

Processor 138 is also illustratively a computer processor with associated memory and timing circuitry (not shown). In one embodiment, processor 138 is a functional component of high fidelity interactive device 110 and is activated by other components thereof (including surface 132) to facilitate the functionality of those components.

FIG. 1 also shows examples of the variety of additional devices that can be used with device 110 as well. For instance, when employed in a grocery store, device 110 may illustratively be connected to scale 116 so that produce or other items that are priced by weight can be measured. As mentioned above, in one embodiment, surface 132 has an integrated scale so a product can be weighed simply by placing it on surface 132. Similarly, device 110 can be coupled to printer 118 for printing a shopping list 140, a receipt 142 or a suggested route 144 through store 102 to pick up purchased items. Of course, printer 118 can be used to print a wide variety of other items, such as product reviews, product research information, coupons, product pricing information, etc.

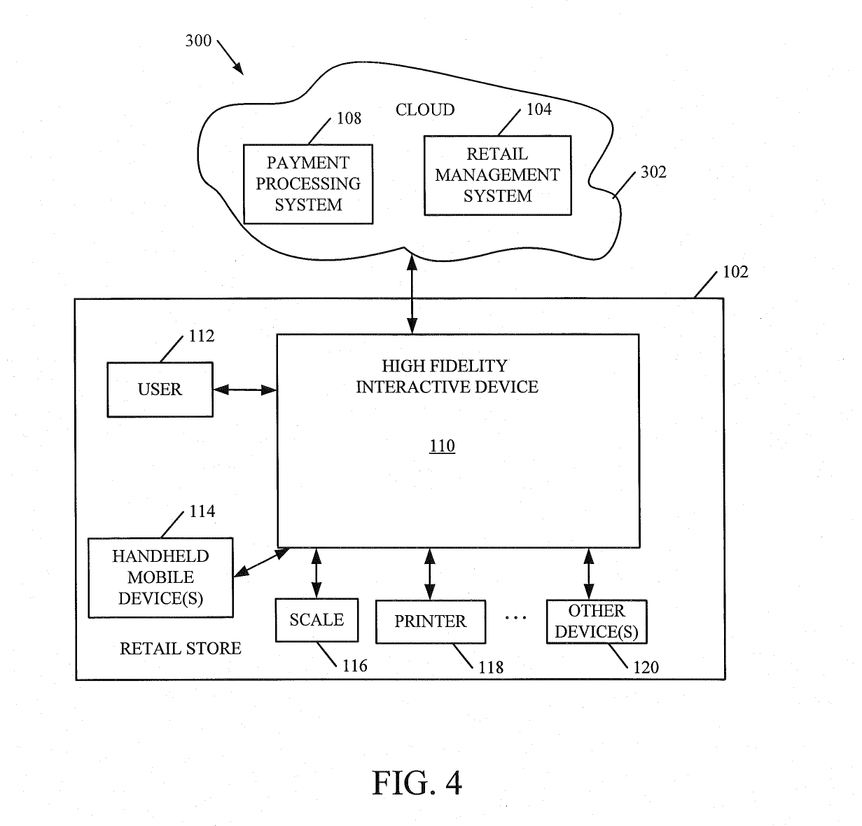

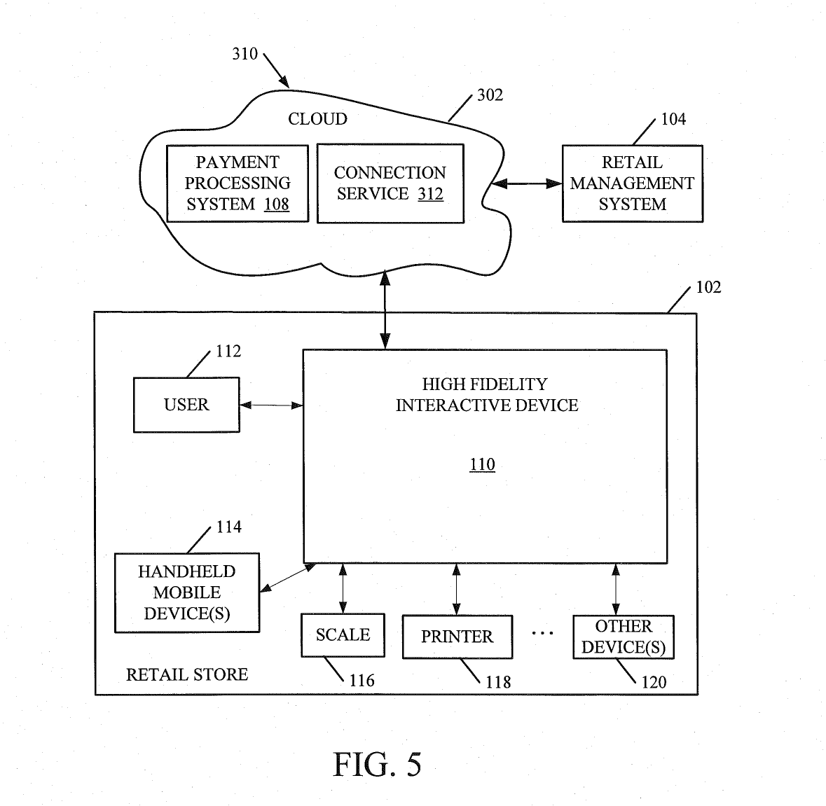

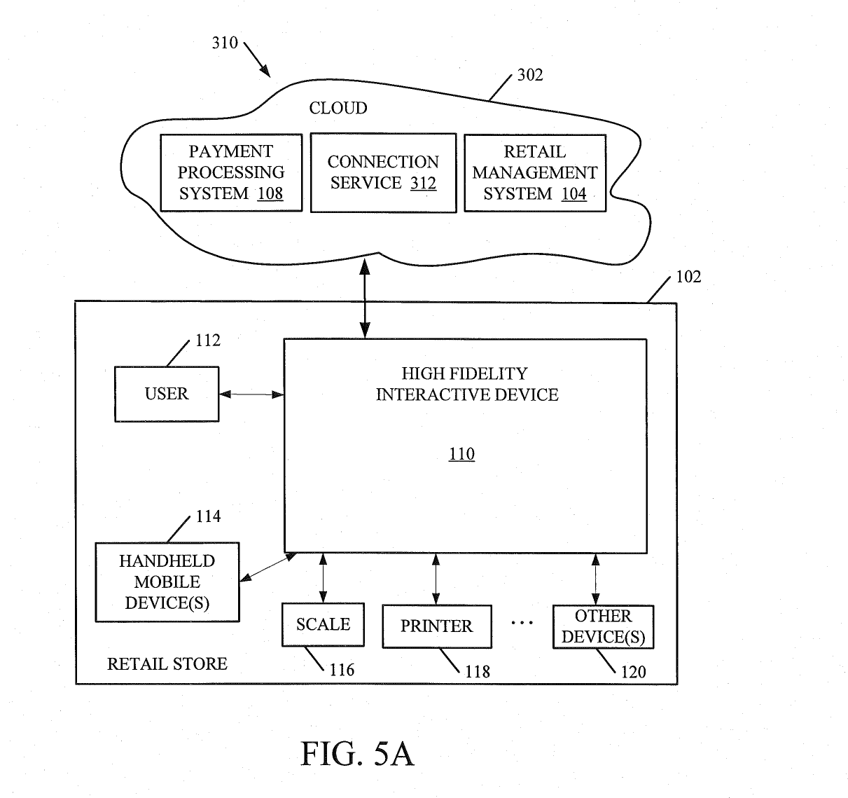

FIG. 1 also shows that device 110 can be connected to retail management system 104 and payment processing system 108 either directly (as indicated by dashed arrows 146 and 148) or through a connection service 150. In one embodiment, as described below with respect to FIGS. 4 and 5, connection service 150 is located in a cloud computing architecture. Other architectures can be used as well.

Briefly, in operation, user 112 illustratively enters retail store 102 and encounters one or more high fidelity interactive devices 110. User 112 can then use a device 110 in order to research products in store 102, and to actually select products for purchase, enter payment information to pay for those products, and then receive not only a receipt 142 (along with an optional list of items just purchased 140) but also optionally a suggested route 144 through store 102, that shows the most efficient way of collecting the purchased items. While FIG. 1 shows that list 140, receipt 142 and suggested route 144 can be printed out for the user, they can also be provided to user 112 through the user's handheld mobile device 114.

The operation of system 100 is now described in greater detail, FIG. 2 is a flow diagram showing one embodiment of the operation of system 100, and FIGS. 2A-2D are block diagrams of exemplary user interface displays. FIGS. 2-2D will now be described in conjunction with one another.

First, user 112 enters store 102. This is indicated by block 160 in FIG. 2. At that point, user 112 illustratively encounters one or more high fidelity interactive devices 110, and approaches one of them for a shopping experience.

In one embodiment, the user interface component 136 may generate a user interface display that allows user 112 to select one of a plurality of different communication modes, by interacting with surface 132. This is indicated by block 172 in FIG. 2. For instance, in one embodiment, the user can simply proceed to interact with device 110 through surface 132. In that case, the user may make an implicit selection of communicating through surface 132. This is indicated by block 174 in FIG. 2.

In another embodiment, user interface component 136 offers the user the option to communicate through the user's handheld mobile device 114 (such as through a smart phone). In that case, user interface component 136 can simply display a button that allows the user to connect his or her mobile device 114 to device 110. Of course, the user 112 may initiate this communication through mobile device 114 as well. In any case, initiating communication with handheld mobile device 114, instead of through surface 132, is indicated by block 176 in FIG. 2.

Of course, device 110 can be configured to communicate with user 112 in other ways as well. The communication can be direct communication, wireless communication, network-based communication, or using a wide variety of other communication technologies. Communicating using any of these other modes is indicated by block 178 in FIG. 2.

Once the mode of communication has been selected by user 112, device 110 conducts communication with the user 112 using the selected mode. Where the mode used is other than through surface 132, communication component 134 illustratively actuates the communication systems for implementing that communication. By way of example, the communication with a handheld mobile device 114 can be using SMS, NFC. Bluetooth, electronic mail (E-mail), etc. Other communication modes can be used as well. Conducting communication with the user through the selected mode is indicated by block 180 in FIG. 2.

In accordance with one embodiment, the user selects a communication mode in which device 110 conducts communication with user 112 through surface 132. This can be done in a wide variety of different ways, and some of those will now be described. For instance, the device 110 approached by the user can receive a user input initiating a sales process. This is indicated by block 181 in FIG. 2. This can be done in a wide variety of different ways as well. In one embodiment, user interface component 136 in device 110 generates a user interface display on surface 132 that allows the user to simply touch the surface anywhere, or touch an actuable link or other element on the display on the surface to initiate an operation.

Once an operation is initiated, device 110 can conduct communication through surface 132 by performing pre-sale processing based on user touch inputs on surface 132. This is indicated block 182 in FIG. 2. By way of example, user interface component 136 can provide a user interface display that allows user 112 to research goods (as shown at block 194), browse through a plurality of different goods (as shown at block 196), generate a shopping list of goods that the user desires to purchase (as indicated by block 200), browse whether goods are in stock (as indicated by block 202), and for selected goods, browse consumer reviews of those goods (as indicated by block 198) as well as see product specifics corresponding to those goods, or perform other processing (as indicated by block 206).

FIGS. 2A and 2B show user interface displays 164 and 165 that can be generated by user interface component 136 and displayed on multi-modal interactive surface 132. In one embodiment, display 164 illustratively includes actuable buttons that allow a user to take action on surface 132. In one embodiment, display 164 includes a “browse goods” button 166, a “alphabetical” button 168, and a “by subject matter” button 170. By way of example, user 112 may actuate browse goods button 166, and user interface component 136 then generates a user interface display on surface 132 that allows the user to view products either alphabetically (by actuating button 168) or by subject matter (by actuating button 170). In either case, once the user interface display 164 illustratively provides user input mechanisms that can be actuated by user 112 in order to browse through various goods, the user shops for various goods.

User interface display 164 may also include other user actuable inputs as well, and those shown are for exemplary purposes only. Other examples are discussed below with respect to FIGS. 3A-3G.

Once user 112 has selected a good from user interface display 164, user interface component 136 can generate another user interface display, such as user interface display 165 for the selected good. In one embodiment, user interface display 165 includes a display portion 184 that displays a picture and textual description of the selected good. For example, assume that the user is shopping for skis. Assume further that the user has browsed through a plurality of different sets of skis using the interface display 164 shown in FIG. 2A. Then, assume that the user has selected one of those different sets of skis for further browsing. When user interface component 136 generates display 165, the selected set of skis is displayed, or described, in the display portion 184.

User interface display 165 is also shown with a plurality of additional actuable user input buttons. In one embodiment, display 165 includes a product specifics button 186, a reviews button 188 and an add to shopping cart button 190. In one embodiment, specifics button 186 can be actuated by the user to have additional product specifics, such as product specifications, price, whether the product is currently in stock, the product's location within the store, comparisons against other products, etc, displayed along with display portion 184.

In the embodiment described with respect to FIG. 1, in order to generate these displays, device 110 communicates with line of business components 106, and specifically inventory/price component 122, store location component 124 and research component 126. In order to display the price and whether the selected good is in stock device 110 illustratively retrieves that information from inventory/price component 122. In order to display a location within the store where the selected good resides, device 110 illustratively accesses component 124 to obtain that information. In order to present additional specifics regarding the selected good, device 110 illustratively interacts with research component 126. Research component 126, itself, can access product information store 128 to obtain additional, more detailed, information about the selected good. In one embodiment, data store 128 also includes reviews by other consumers for the selected good. Therefore, if in FIG. 2B the user actuates the “reviews” button 188, research component 126 can provide other consumer reviews of the selected goods for use by user interface display component 136, and those reviews can be displayed along with display portion 184.

In accordance with another embodiment, system 100 can perform additional pre-sale processing as well. For instance, user interface component 136 can access e-commerce component 121 to generate e-commerce displays 192 on display 165 as well (as indicated by block 204). That is, where a user has selected a good for display at display portion 184, e-commerce component 121 can illustratively access customer data to identify additional products that customers may be willing to buy, if they buy the goods selected by user 112. Similarly, e-commerce component 12.1 can identify more expensive products that can be used in an attempt to up-sell the user 112, to buy a more advanced product, or more expensive product. E-commerce component 121 can also be used by user interface component 136 to generate e-commerce displays 192 that offer entry into loyalty programs, and provide an opportunity for user 112 to generate a profile and input profile information. Other e-commerce displays 192 can be generated as well.

Once the user has decided to purchase a product, the user can add it to a shopping cart. This can be done in different ways. In one embodiment the user actuates “Add to Shopping Cart” button 190 and proceeds to a checkout process, if desired. In that embodiment, user interface component 136 illustratively interacts with payment processing system 108 to generate user interface displays on surface 132 that allow the user to checkout. All of this requires device 110 to perform sales processing based on user inputs, such as touch inputs or using other input mechanisms. This is indicated by block 210 in FIG. 2.

In one embodiment, user interface component 136 generates a user interface display on surface 132 such as that indicated at 212 in FIG. 2C. FIG. 2C shows a block diagram of a user interface display 212 that provides the user with a payment selector 214 and a payment specifics display 216. In one illustrative embodiment, payment selector 214 displays a number of user actuable input mechanisms that allow a user to select a type of payment the user wishes to use. This can be cash, check, credit or debit card, chip card, or another type of payment option.

In any case, once the user has selected the appropriate payment selector 214, user interface component 136 interacts with the appropriate payment processing system 108 to generate user input displays on display 212 to collect payment specifics 216 from the user. For instance, if the user is using a credit card, user interface component 136 generates a user interface display 212 that allows the user to input, as payment specifics 216, the credit card number, expiration date, security code, zip code, user name, etc. Alternatively, multi-modal interactive surface 132 may be equipped to read a credit card if the user simply sets the credit card on surface 132. This can be done using vision processing, using a magnetic strip reader provided along with surface 132, or using a chip card reader associated with surface 132, in any case, device 110 receives the product selection by the user indicating the product to be purchased, and then receives all of the payment information (mode of payment and payment specifics) to conduct the sales transaction. Receiving the product selection is indicated by block 220 in FIG. 2 and receiving the payment specifics is indicated by block 222. Of course, device 110 can perform other sales processing based on the user inputs as well. This is indicated by block 224 in FIG. 2.

Once payment has been made, device 110 can perform post-sale processing for user 112 as well. This is indicated by block 219 in FIG. 2. This can be done in a wide variety of different ways. For instance, device 110 can generate a receipt as indicated by block 226 in FIG. 2, or it can generate a purchase summary as indicated by block 228. By way of example, the receipt can list all of the products that the user has purchased, along with their price, and an indication that they have been paid for. This can be provided to the user either in hard copy through printer 118, or it can be sent to a handheld or other mobile device 114 used buy user 112. Similarly, a purchase summary can be generated which summarizes in more detail the goods purchased by the user and the summary can be provided to the user in multiple different ways as well, including a hard copy or a soft copy through the user's mobile device 114.

In addition, device 110 can interact with store location component 124 to provide an indication to the user that indicates the location in the store of each product purchased. This can take a number of different forms. For instance, on the user's receipt 142 or other purchase summary, device 110 can print out an associated row and shelf identifier that identifies the particular row and shelf in the store where the product is located.

In addition, store location component 124 can also provide information which allows user interface component 136 to generate route information for user 112. For instance, because component 124 knows which products have been purchased, component 124 can calculate the most efficient route through store 102 for the user 112 to follow in order to pick up the purchased goods. Alternatively, of course, component 124 can access other information and route the user 112 past other goods that the user may wish to purchase. For instance, where a line of business component 106 includes a consumer data store that indicates purchasing tendencies, and where that data store shows that a user that is purchasing baby formula may also wish to purchase diapers, store location component 124 may route user 112 past the diapers on the way to pick up the baby formula. This may prompt the user that the user has forgotten that the user needs diapers as well. Similarly, store location component 124 and device 110 can incorporate temporal information. For instance, where the user has purchased a pound of cheese from the deli section of the store, but the user's order will not be ready for 7 minutes, store location component 124 can route the user to a slightly longer route through the store so that the user arrives at the deli section approximately 7.5-8 minutes later. This way, the user is not waiting for the order to be filled at the deli section and this improves the user's shopping experience. Generating the location/route directions is indicated by block 230 in FIG. 2. Of course, device 110 can perform a wide variety of other post-sale processing for user 112 as well, and this is indicated by block 232 in FIG. 2.

In accordance with another embodiment, device 110 also generates a display that allows user 112 to receive the receipt, the purchase summary, the route information, and any other information generated by device 110 on the user's mobile device 114, instead of in hard copy. In performing that processing, device 110 illustratively generates a display such as display 250 shown in FIG. 2D. Display 250 illustratively displays a communication mode selector 252 and receipt selector for receipt 254 along with route selector 256. In this way, user 112 can select the particular mode of communication through which the user wishes to receive receipt 254 and a selector for route information 256. By way of example, the user may wish to receive a hard copy of the receipt 254 from printer 118. In that case, the user can simply select the printer as the mode of communication using selector 252 and actuate the receipt button 254 to get a hard copy of the receipt.

In addition, the user may wish to receive the route information 256 on the user's handheld mobile device 114. In order to accomplish that, the user may simply select mobile device communication using selector 252 and then actuate the route information button 256. In that case, communication component 134 transmits the route information to the user's handheld mobile device 114 using, illustratively, wireless communication. This can be done in a number of different ways as well. For instance, communication component 134 can simply send a .pdf or other static copy of the route information for display on the user's handheld mobile device 114. Alternatively, store location component 124 can include a real-time locating system, such as Wi-Fi triangulation, GPS locators, or other in-store navigation systems. In that case, the route information provided on the user's handheld mobile device 114 can be updated in real-time, based upon the location of user 112 in store 102 and the location of the remaining products that the user has purchased, and which the user has not yet picked up. Thus, if the user deviates off the route initially provided on the user's handheld mobile device 114, store location component 124 and communication component 134 can transmit new route information directing the user 112 through a new route, based upon the user's new location.

While many of the processing steps discussed above can involve communication with retail management system 104, others can be performed locally with no need to communicate immediately with retail management system 104. For instance, device 110 also illustratively conducts post-sale processing in retail management system 104. This is indicated by block 280 in FIG. 2. In one embodiment, device 110 illustratively performs all of the post-sale processing in retail management system 104 in order to complete the sale transaction. For instance, in one embodiment, device 110 interacts with inventory/price component 122 to update the inventory to indicate that user 112 has purchased an item. Similarly, device 110 can interact with business/accounting components 123 to post the sale to the general ledger, or to otherwise account for the sale in line of business components 106 of retail management system 104. Updating the inventory is indicated by block 282 in FIG. 2 and posting the sale to the ledger is indicated by block 284 in FIG. 2. Of course, device 110 can interact with retail management system 104 to perform a wide variety of other post-sale processing in retail management system 104 as well. This is indicated by block 286 in FIG. 2. In addition, the transaction can be noted or posted, or otherwise accounted for, by communicating it to a dedicated accounting or financial system outside of retail management system 104 as well.

FIGS. 3A-3G show a set of exemplary user interface displays generated by user interface component 136 on multi-modal interactive surface 132 of high fidelity interactive device 110. The displays shown in FIGS. 3A-3G are exemplary only, but illustrate some examples of user interface displays and gestures that can be used to accomplish a number of different tasks on device 110.

FIG. 3A, for example, shows two different displays 400 and 402, that can be generated on multi-modal interactive surface 132, FIG. 3A shows that displays 400 and 402 can be displayed in order to allow a user 112 to view product details corresponding to a given product.

It can first be seen that display 400 includes a number of different sections. “My Profile” button 404 can be actuated (such as by tapping, moving a cursor and pressing enter, clicking with a mouse cursor, or otherwise) to create or edit view the personal profile of user 112. The profile information can include a wide variety of different information, such as user preferences, products the user has purchased before, and other things which the user desires to include in the profile information.

Display 400 also includes a “Rewards and Specials” button 406. When this button is actuated, it displays user status in one or more different awards programs or patronage programs that the user has enrolled in. It can also display coupons, specials, sale items, or other offerings by the retailer. These offerings can be tailored to user 112, given the information in the user's profile, or they can be general offerings made to every user.

Display 400 also includes a “Checkout” button 408. When button 408 is actuated, it navigates the user to a checkout screen so that the user can make payment and receive a receipt, a map, or the other items described above with respect to FIGS. 1 and 2.

Display 400 also includes a “Customer Service” button 410. When the user actuates button 410, this can be used to call a customer service attendant to the user's position within the retail store. That way, a customer service attendant can assist the user or answer user questions, or otherwise provide help or service to the user. Calling the customer service attendant can be done in a variety of different ways as well. For instance, high fidelity interactive device 110 can send a message to a pager or cell phone or smart phone of a customer service attendant requesting help for a user 112. Alternatively, high fidelity interactive device 110 can simply light up a light or other visual display that can be viewed inside the store by a customer service attendant. Alternatively, device 110 can send the customer service staff an electronic mail message, a text message, a voice mail message, a voice prompt, or any other type of message, either by a wireless network, a hard wired local area network or even a wide area network. These are listed by way of example only.

Display 400 also has a “Search” button 412. When the user actuates search button 412, the user is illustratively navigated to a screen, such as that shown in FIG. 3A, in order to browse or otherwise search for goods. The goods can be listed alphabetically, by subject matter, they can be searched using a browser interface, or in any other desired way.

Display 400 also shows that the contents of the file user's current shopping cart is shown in shopping cart section 414 of display 400. Shopping cart section 414 shows a plurality of different products 416 that the user currently has included in his or her shopping cart. It illustratively provides a picture or other graphic representation of the goods, along with the quantity of goods being purchased and the total price of each of the goods. Further, a checkout total price portion 418 is displayed and shows the total price for all goods currently in the user's shopping cart section 414.

Display 400 also includes a browsing section 420. Browsing section 420, in the embodiment shown in FIG. 3A, has a plurality of tiles 422, 424 and 426. Each tile represents a product. The tile illustratively shows a picture or graphical representation of the product, along with a textual description of the product, and a cost of the product.

In one embodiment, it should be noted that shopping cart section 414 and browsing section 420 are both illustratively scrollable. For instance, where display 400 includes a touch sensitive surface, the user can use touch gestures in order to cause the list shown in browser section 420 to scroll to the right or to the left in order to display different products. Similarly, as the user's shopping cart section 414 fills with products, the user can use touch gestures to scroll that list of products to the right or to the left in order to see all of the products in the shopping cart. The touch gestures can take a wide variety of different forms. For instance, the user may use a finger or stylus to swipe to the left or to the right along either section 414 or section 420 in order to scroll the list of products in the respective section. Alternatively, the user may use tap gestures which cause the sections to rotate. Similarly, the user can user mouse inputs or even keyboard inputs in order to cause the lists in sections 414 and 420 to scroll. Other gestures or user inputs can be used as well. In any case, user interface component 136 illustratively causes the lists to move in the desired way based on the user inputs.

Display 402 shows that the user has requested to see more details of the “Road Bike” shown on tile 422. In order to do this, the user, starting at display 400, provides a suitable user input to cause user interface component 136 to generate a display showing more details for a selected product. This can be done using a wide variety of touch gestures as well.

For instance, assume that the user is to see more detail about the “Road Bike” shown on tile 422 in display 400. In one embodiment, the user simply taps on the product tile 422 and this causes display 402 to be generated. This can be done in a wide variety of different ways. For instance, in one embodiment, when the user taps on tile 422, it rotates 180 degrees about its Y axis (assuming it has a Y axis extending in the vertical direction in FIG. 3A) then stretches across the entire section 420 to reveal additional details about the product shown on product tile 422. As shown in display 402, tile 422 has now expanded into tile 430 which takes up substantially the entire browser section 420 of display 402. It will be noted that the term browser can refer to a web browser but that need not be the case. The browser can be any system, application or component that allows the user to interact with user interface components to navigate through different user interface displays. The detailed information shown on tile 430 can be any tile that is either desired by the user, desired by the manufacturer of the product, desired by the retailer, or a combination of those things. In order to return to the previous view shown in display 400, from display 402, the user can simply provide another suitable user input. In one embodiment, when the user double taps on tile 430, the display returns to that shown as display 400. Of course, a wide variety of other inputs can be used in order to return to the previous display.

FIG. 3B is similar to FIG. 3A, and similar items are similarly numbered. However, FIG. 3B shows another embodiment for viewing product details, referred to herein as a progressive view of product details. It can be seen in FIG. 3A that display 432 includes a slider 434 that can be used to set the detail shown for each of the products. In display 432, slider 434 is set to the “Brief” setting. However, when the user moves the slider to the “Detailed” setting as shown in display 436, then more details are shown for a selected product tile, in the embodiment shown in FIG. 3B, the user has already selected product the 422, and then moved slider 434 to the “Detailed” position shown in display 436. This causes tile 422 to expand to show the additional product details, as shown on tile 430 on display 436.

It should also be noted that in FIG. 3B, the slider has a plurality of different detail settings progressing from “List” to “Thumbnails”, to “Brief”, to “Detailed”, to “Complete”. In one embodiment, the “List” setting simply provides a textual listing of the products being displayed. The “Thumbnails” setting shows small thumbnails of each product, such as those shown in the shopping cart section 414 of the display. The “Brief” section is shown in display 432 and one embodiment of the “Detailed” setting is shown in display 436. The “Complete” setting may include even more reviews, such as more detailed customer reviews, shipping details, color selection details, accessories, etc. These detail settings are given by way of example only and other or different settings could be used as well.

In order to move the slider 434 among the various positions shown, the user 112 simply provides a suitable user input to user interface component 136. For instance, the user can drag and drop the slider using touch gestures such as by tapping on the slider button and moving it and sliding the user's finger across the display to move the slider to a desired location. Alternatively, the user can use swipe gestures to move the slider more quickly, or the user can use other gestures or user input devices, such as a mouse or keyboard.

It will be noted that using slider 434 is not the only way to progressively display more or less information. Other ways can be used as well. For instance, touch gestures can be used. By way of example, a user can touch the display with two fingers and move them toward one another in a pinching gesture. This can reduce the amount of detail displayed. If the user moves the fingers in a reverse pinching gesture (by spreading them apart), this can increase the amount of detail displayed. This is but one example.

FIG. 3C shows another set of user interface displays that can be generated when a user wishes to search for related items. That is, when the user selects one of the product tiles on display 400 and wishes to look for other related items. FIG. 3C shows what displays can be generated in order to do that. By way of example, assume that, starting from display 400, the user wishes to see other items related to the “Skateboard” shown on product tile 424 in display 400. In that case, the user simply provides a user input indicating that the user wishes to see more details. In the embodiment discussed with respect to FIG. 3C, the user selects tile 424 and moves it down to the browser or search button 412. Display 440 shows that the user has selected tile 424 and begun to move it, and display 442 shows that the user has moved tile 424 onto search button 412. In one embodiment, a visual cue is provided to the user, such as tile 444 which is shown on search button 412. In addition, the text on search button 412 indicates to the user that related items are being sought. For instance, the icon corresponding to tile 424 is disposed as shown one tile 444 on search button 412, and the text has been changed to “Searching products similar to Skateboard . . . ”.

When the search is complete, or as search results are retrieved, display 446 is generated. It can be seen that, in addition to tile 424, tiles 448 and 450 are now shown in product browsing section 420 of display 446. Both of the products corresponding to tiles 448 and 450 are related to the product shown on tile 424. Again, the user inputs used to initiate this type of searching can vary. In one embodiment, they are touch gestures, in that case, the user simply taps or double taps on tile 424 to move the user interface into drag and drop mode, and then drags tile 424 to the position shown at 444 in display 442 and drops it there. Alternatively, if the user is using a mouse, the user can simply drag and drop tile 424 using the mouse. Other touch gestures or other user input mechanisms can be used as well.

FIG. 3D shows a set of user interface displays that can be used to add a product to the cart. Again, assuming that the user starts with display 400, and assume that the user wishes to move the product displayed on tile 426 to the shopping cart, the user can simply drag and drop the product on tile 426 to shopping cart section 414 on display 400. This can be done using a wide variety of different user input mechanisms. In one embodiment, touch gestures can be used so that tapping on tile 426 causes tile 426 to be displayed in a drag and drop mode. The user can then drag it to shopping cart section 414. This is shown in display 452. It can be seen that a variety of different visual cues can be used to show that the product is being added to the shopping cart. The original copy of tile 426 can be displayed in a de-emphasized way, as the user is moving tile 426 to shopping cart section 414, if, in an intermediate state, as shown in display 452, the user releases tile 426, it illustratively snaps back to the position shown on display 400, and is not added to the shopping cart section 414.

However, as soon as the user has dragged tile 426 to the shopping cart section 414, as shown in display 454, it is provisionally added to the shopping cart.

Visual cues can be given to show this as well. In the embodiment shown in display 454, the product tile 42.6 has been shrunk down and is displayed with a dashed line around it indicating that it has been provisionally added to shopping our section 414. The total price for 418 is updated including the provisional addition of the product on tile 426. However, the addition of the product to the shopping cart section 414 is not completed until the user actually drops tile 426 there by releasing it from the drag and drop mode. When this happens, tile 426 is shown, illustrating that the user has now added the product associated with tile 426 to the shopping cart section 414.

Again, visual cues can be provided to the user indicating this. Tile 426, in shopping cart section 414, now no longer has a dashed line around it, but instead has a solid line around it. The tile can change color (such as from blue to green, or any other color) also providing a visual indication that it has been added to the shopping cart. Further, the tile 426 in browser region 420 can change colors or boldness or provide another visual indication that it has been included in the shopping cart as well. For instance, where a standard product tile is green, it can be changed to blue once it has been added to the shopping cart section 414. Of course, other visual indications can be provided as well.

It should also be noted that other user inputs can be provided to add a product to the shopping cart. For example, even swipe touch gestures can be used. If the user swipes upwardly on tile 424, it can be added to shopping cart section 414. Other gestures can be used as well.

FIG. 3E shows a set of displays that can be generated by user interface component 136 that allow a user to remove an item from the shopping cart section 414. The user interface display shown in FIG. 3E shows how a user can both reduce the quantity of an item being purchased in shopping cart section 414, and remove an item all together from shopping cart section 414. Again, assuming that the user starts from display 400, and the user wishes to reduce the number of football helmets on the football helmet tile 416 on display 400, the user can do this by simply providing a suitable user input to reduce the number of units. In the embodiment shown in FIG. 3E, the user can use a touch gesture and swipe in the downward direction on the football helmet tile 416 causing the number of units purchased to be reduced. This is shown in display 458.

As the user swipes down on tile 416, the number of pieces to be purchased in shopping cart section 414 reduces from 2 to 1 as shown in display 460. This can be used on any tile in shopping cart section 414 in order to reduce the number of units or pieces of that product purchased. Also, the gestures can be different as well. For instance, when the user uses a large or fast downward swipe, this can reduce the number of units by more than one. Similarly, if the user uses a large or fast upward swipe, this can increase the number of units to be purchased by more than one. Of course, if the user uses a small or slower swipe, this may change the number of units to be purchased in a slower fashion. Alternatively, of course, in another embodiment, if the user uses any type of swipe, the number of pieces may be increased or reduced by only 1.

In any case, once the user has reached the minimum number of units to be purchased, if the user again provides a user input, such as a downward swipe gesture on tile 416, this causes the product to be completely removed from shopping cart section 414. This is shown in display 462.

Display 464 shows that the football helmet has now been completely removed from shopping cart section 414. Display 466 shows that, in one embodiment, the tiles in shopping cart section 414 are then rearranged so that they are closely aligned with one another, after the football helmet has been moved.

FIG. 3F shows a set of displays generated by user interface component 136 and allow a user to remove a batch quantity item from shopping cart section 414 in a different way. Instead of swiping downwardly on the product tile 416 in shopping cart section 414, until the quantity reaches its lowest level, and then swiping yet again to remove it from the shopping cart section 414, FIG. 3F shows that, no matter what the quantity of items corresponding to a given tile the user can remove the entire quantity using a single gesture. Again, starting from display 400, it can be seen that tile 416, corresponding to the football helmet in display 400, includes two pieces. However, assume that the user no longer wishes to purchase any football helmets. In that case, the user can provide a suitable user input to completely remove the tile 416 corresponding to the football helmets from the shopping cart section 414. As shown in display 468, one way of doing this is by the user providing a two finger down swipe gesture on the tile 416 corresponding to the football helmet. In that embodiment, it is assumed that multi-modal interactive surface 132 is a multi-touch surface which can detect multiple touches on the surface at the same time. Therefore, when the user places two fingers on tile 416 corresponding to the football helmet and swipes downwardly, this causes the entire tile to be removed from the shopping cart section 414, as shown in display 470, regardless of how many pieces were initially shown on the tile. Display 472 shows that the shopping cart section 414 has now been modified so that the tile 416 corresponding to the football helmet is no longer present, and the total cost illustrated at 418 has been updated as well. Display 474 shows that the tiles 416 in shopping cart section 414 are rearranged to accommodate for the removal of the football helmet tile.

FIG. 3G shows a set user of interfaces that are generated by user interface component 136, and that allow a user to update a batch quantity of items, without having to generate multiple up swipe gestures to increase the quantity. Again, starting from display 400, assume that the user wishes to change the number of sets of boxing gloves that the user wishes to purchase, in that case, in one embodiment, the user simply presses and holds tile 416 corresponding to the boxing gloves in shopping cart section 414. This is shown at display 476 and indicates that the user wishes to enter batch update mode to update the quantity of items to be purchased. In that case, a visual queue is provided to the user indicating that the user is about to be presented with a user interface display that allows the user to update the batch quantity of items corresponding to the boxing glove tile 416. In one embodiment, the tile rotates about its Y axis and changes to a “Enter Quantity” display such as tile 482 shown on display 478. In addition, in one embodiment, a keyboard section 484 is displayed which allows the user to enter the numeric quantity of items to be purchased. Display 478 shows that the user has entered the quantity 4 and, once the user presses enter, display 480 shows that the updated tile 416 corresponding to the boxing gloves has 4 pieces. In addition, the total price indicator at 418 is updated to now show the total price of the products in the shopping cart section 414.

All of the user interface displays described above are exemplary only. Others can be used as well or instead.

FIG. 4 is a block diagram of system 100, shown in FIG. 1, except that it is disposed in a cloud computing architecture 300. Cloud computing provides computation, software, data access, and storage services that do not require end-user knowledge of the physical location or configuration of the system that delivers the services. In various embodiments, cloud computing delivers the services over a wide area network, such as the internet, using appropriate protocols. For instance, cloud computing providers deliver applications over a wide area network and they can be accessed through a web browser or any other computing component. Software or components of system 100 as well as the corresponding data, can be stored on servers at a remote location. The computing resources in a cloud computing environment can be consolidated at a remote data center location or they can be dispersed. Cloud computing infrastructures can deliver services through shared data centers, even though they appear as a single point of access for the user. Thus, the components and functions described herein can be provided from a service provider at a remote location using a cloud computing architecture. Alternatively, they can be provided from a conventional server, or they can be installed on client devices directly, or in other ways.

The description is intended to include both public cloud computing and private cloud computing. Cloud computing (both public and private) provides substantially seamless pooling of resources, as well as a reduced need to manage and configure underlying hardware infrastructure.

A public cloud is managed by a vendor and typically supports multiple consumers using the same infrastructure. Also, a public cloud, as opposed to a private cloud, can free up the end users from managing the hardware. A private cloud may be managed by the organization itself and the infrastructure is typically not shared with other organizations. The organization still maintains the hardware to some extent, such as installations and repairs, etc.

In the embodiment shown in FIG. 4, some items are similar to those shown in FIG. 1 and they are similarly numbered. FIG. 4 specifically shows that payment processing system 108 and retail management system 104 are both located in cloud 302 (which can be public, private, or a combination where portions are public while others are private). Therefore, device 110 simply accesses those systems through cloud 302.

FIG. 5 shows another embodiment of another cloud architecture 310. Some items shown in FIG. 5 are similar to those shown in FIG. 4 and are similarly numbered. However, in the embodiment shown in FIG. 5, device 110 connects, through cloud 302, to connection service 312. Connection service 312, itself, connects device 110 with retail management system 104 and payment processing system 108. Of course, it should be noted that in other embodiments, retail management system 104 includes back office retail applications, enterprise resource planning applications, customer relations management applications, or any of a wide variety of other applications as well. Those applications can be located within retail store 102, at a headquarters, or otherwise. Regardless of where they are located, they are accessed directly by device 110, through a network, (either a wide area network or a local area network) they can be hosted at a remote site by a service, or they can provided as a service through a cloud or accessed by a connection service that resides in the cloud. All of these architectures are contemplated herein.

FIG. 5A shows other cloud-based implementations. FIG. 5A is similar to FIG. 5 and similar items are similarly numbered. FIG. 5A shows that, even when connection service 312 is used, retail management system 104 can reside in the cloud 302 as well.

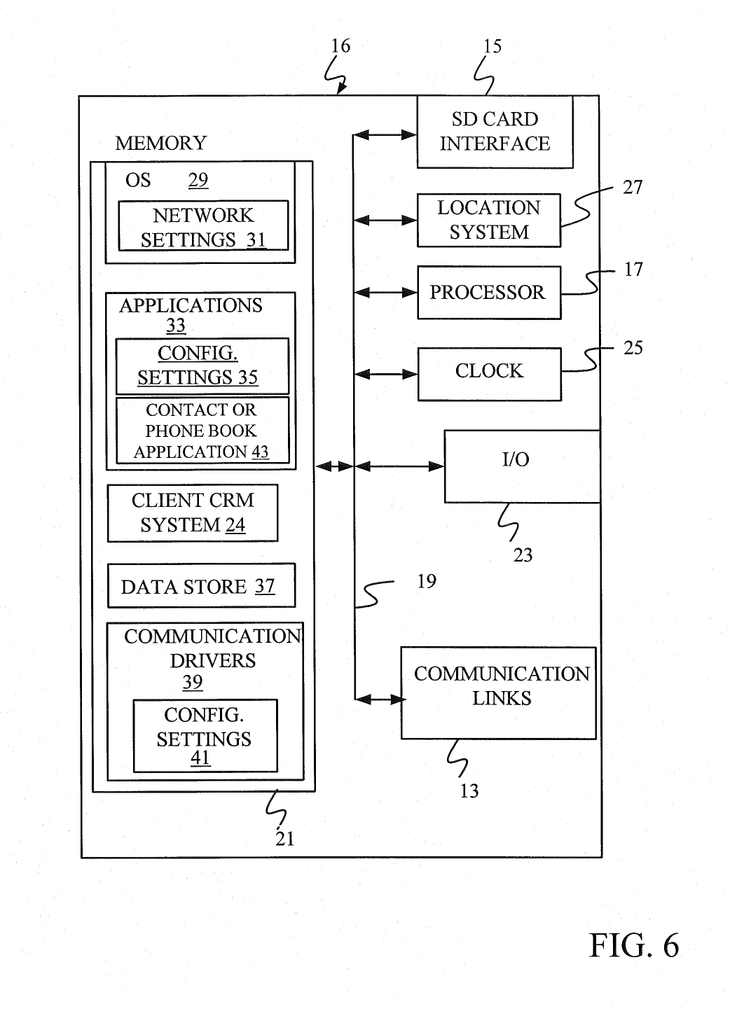

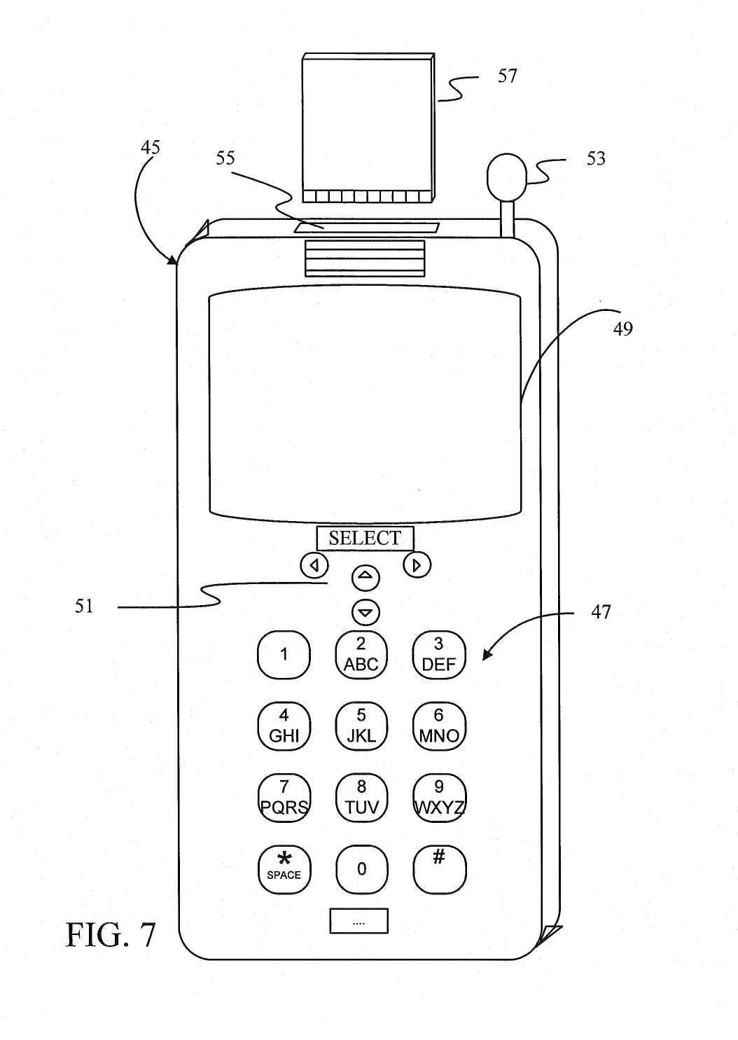

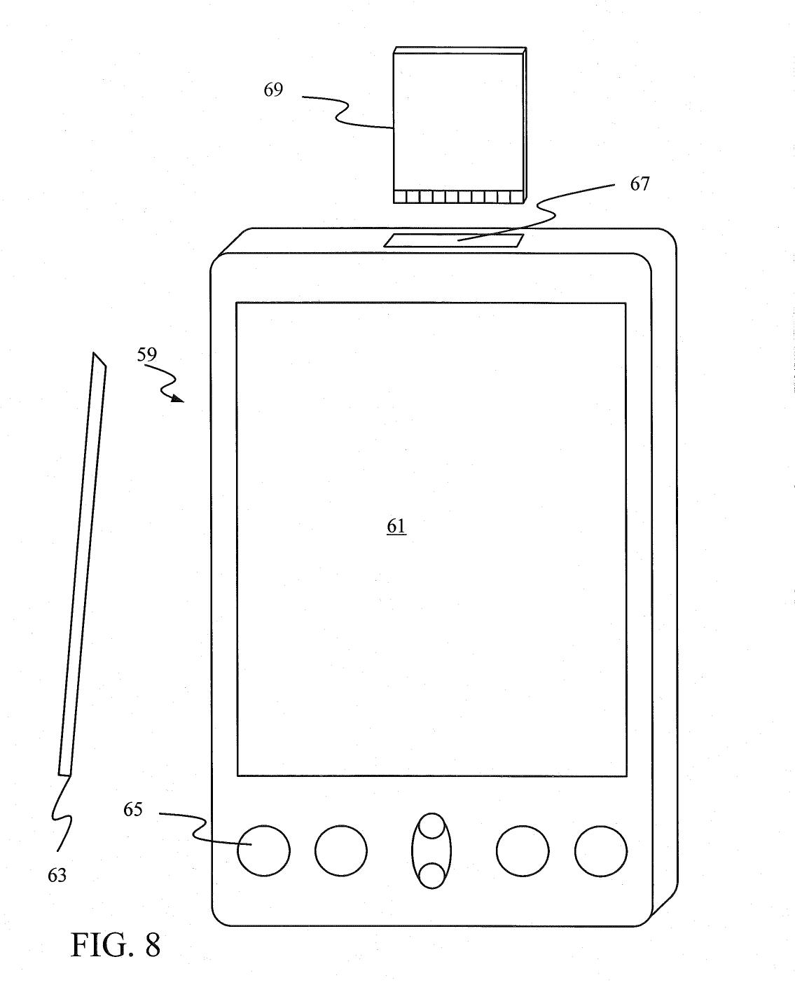

FIG. 6 is a simplified block diagram of one illustrative embodiment of a handheld or mobile computing device that can be used as a user's or client's hand held device 16, in which the present system can be deployed. FIGS. 7 and 8 are examples of handheld or mobile devices.

FIG. 6 provides a general block diagram of the components of a client device 16 that can run components of system 100 or that interacts with system 100, or both. In the device 16, a communications link 13 is provided that allows the handheld device to communicate with other computing devices and under some embodiments provides a channel for receiving information automatically, such as by scanning Examples of communications link 13 include an infrared port, a serial/USB port, a cable network port such as an Ethernet port, and a wireless network port allowing communication though one or more communication protocols including General Packet Radio Service (GPRS), LTE, HSPA, HSPA+ and other 3G and 4G radio protocols, 1xrtt, and Short Message Service, which are wireless services used to provide cellular access to a network, as well as 802.11 and 802.11b (Wi-Fi) protocols, and Bluetooth protocol, which provide local wireless connections to networks.

Under other embodiments, applications or systems (like system 100) are received on a removable Secure Digital (SD) card that is connected to a SD card interface 15. SD card interface 15 and communication links 13 communicate with a processor 17 (which can also embody processors 130 or 138 from FIG. 1) along a bus 19 that is also connected to memory 21 and input/output (I/O) components 23, as well as clock 25 and location system 27.

I/O components 23, in one embodiment, are provided to facilitate input and output operations. I/O components 23 for various embodiments of the device 16 can include input components such as buttons, touch sensors, touch screens, proximity sensors, microphones, tilt sensors, and gravity switches and output components such as a display device, a speaker, and or a printer port. Other I/O components 23 can be used as well.

Clock 25 illustratively comprises a real time clock component that outputs a time and date. It can also, illustratively, provide timing functions for processor 17.

Location system 27 illustratively includes a component that outputs a current geographical location of device 16. This can include, for instance, a global positioning system (GPS) receiver, a LORAN system, a dead reckoning system, a cellular triangulation system, or other positioning system. It can also include, for example, mapping software or navigation software that generates desired maps, navigation routes and other geographic functions.

Memory 21 stores operating system 29, network settings 31, applications 33, application configuration settings 35, data store 37, communication drivers 39, and communication configuration settings 41. Memory 21 can include all types of tangible volatile and non-volatile computer-readable memory devices. It can also include computer storage media (described below). Memory 21 stores computer readable instructions that, when executed by processor 17, cause the processor to perform computer-implemented steps or functions according to the instructions. System 10 or the items in data store 18, for example, can reside in memory 21. Processor 17 can be activated by other components to facilitate their functionality as well.

Examples of the network settings 31 include things such as proxy information, Internet connection information, and mappings. Application configuration settings 35 include settings that tailor the application for a specific enterprise or user. Communication configuration settings 41 provide parameters for communicating with other computers and include items such as GPRS parameters, SMS parameters, connection user names and passwords.

Applications 33 can be applications that have previously been stored on the device 16 or applications that are installed during use, although these can be part of operating system 29, or hosted external to device 16, as well.

FIGS. 7 and 8 provide examples of devices 16 that can be used, although others can be used as well. In FIG. 7, a smart phone or mobile phone 45 is provided as the device 16. Phone 45 includes a set of keypads 47 for dialing phone numbers, a display 49 capable of displaying images including application images, icons, web pages, photographs, and video, and control buttons 51 for selecting items shown on the display. The phone includes an antenna 53 for receiving cellular phone signals such as General Packet Radio Service (GPRS) and 1xrtt, and Short Message Service (SMS) signals. In some embodiments, phone 45 also includes a Secure Digital (SD) card slot 55 that accepts a SD card 57.

The mobile device of FIG. 8 is a personal digital assistant (PDA) 59 or a multimedia player or a tablet computing device, etc, (hereinafter referred to as PDA 59), PDA 59 includes an inductive screen 61 that senses the position of a stylus 63 (or other pointers, such as a user's finger) when the stylus is positioned over the screen. This allows the user to select, highlight, and move items on the screen as well as draw and write, PDA 59 also includes a number of user input keys or buttons (such as button 65) which allow the user to scroll through menu options or other display options which are displayed on display 61, and allow the user to change applications or select user input functions, without contacting display 61. Although not shown, PDA 59 can include an internal antenna and an infrared transmitter/receiver that allow for wireless communication with other computers as well as connection ports that allow for hardware connections to other computing devices. Such hardware connections are typically made through a cradle that connects to the other computer through a serial or USB port. As such, these connections are non-network connections. In one embodiment, mobile device 59 also includes a SD card slot 67 that accepts a SD card 69.

Note that other forms of the devices 16 are possible. Examples include tablet computing devices, music or video players, and other handheld computing devices.

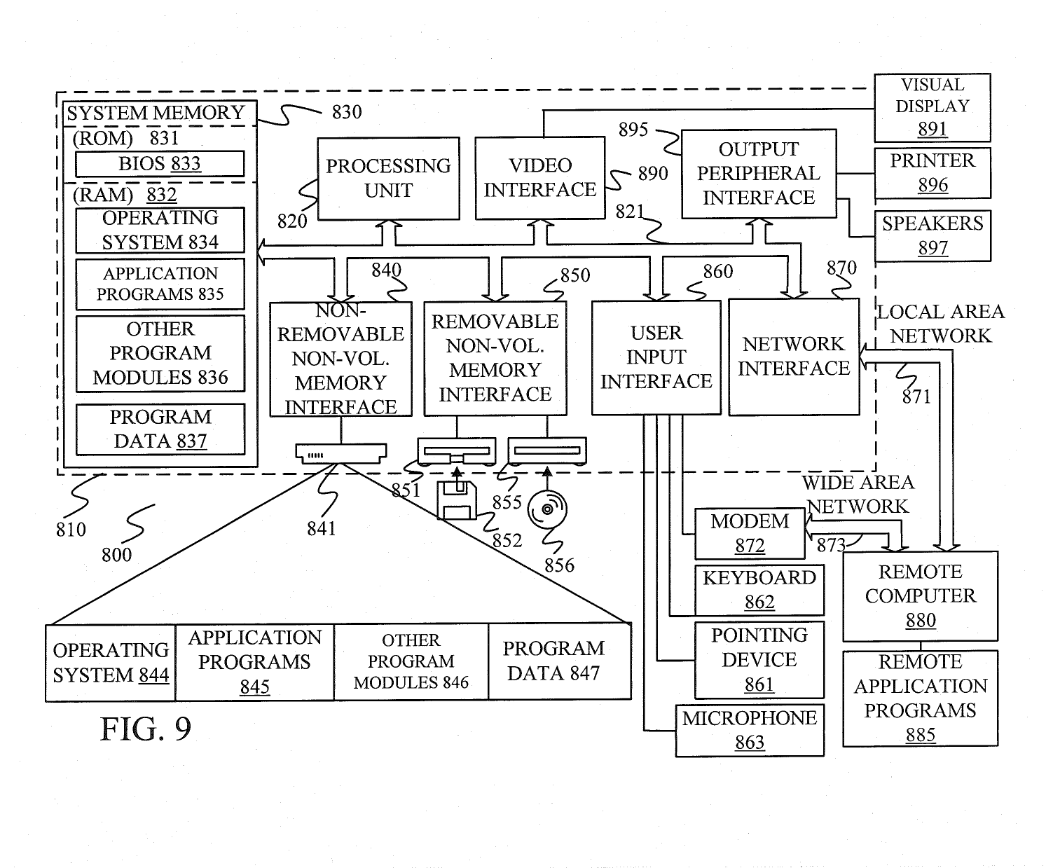

FIG. 9 is one embodiment of a computing environment in which system 100 (for example) can be deployed. With reference to FIG. 9, an exemplary system for implementing some embodiments includes a general-purpose computing device in the form of a computer 810. Components of computer 810 may include, but are not limited to, a processing unit 820 (which can comprise processor 130 or 138), a system memory 830, and a system bus 821 that couples various system components including the system memory to the processing unit 820. The system bus 821 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component interconnect (PCI) bus also known as Mezzanine bus. Memory and programs described with respect to FIG. 1 can be deployed in corresponding portions of FIG. 9.

Computer 810 typically includes a variety of computer readable media. Computer readable media can be any available media that can be accessed by computer 810 and includes both volatile and nonvolatile media, removable and non-removable media. By way of example, and not limitation, computer readable media may comprise computer storage media and communication media. Computer storage media is different from, and does not include, a modulated data signal or carrier wave. It includes hardware storage media including both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 810. Communication media typically embodies computer readable instructions, data structures, program modules or other data in a transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

The system memory 830 includes computer storage media in the form of volatile and/or nonvolatile memory such as read only memory (ROM) 831 and random access memory (RAM) 832. A basic input/output system 833 (BIOS), containing the basic routines that help to transfer information between elements within computer 810, such as during start-up, is typically stored in ROM 831, RAM 832 typically contains data and/or program modules that are immediately accessible to and/or presently being operated on by processing unit 820. By way of example, and not limitation, FIG. 9 illustrates operating system 834, application programs 835, other program modules 836, and program data 837.

The computer 810 may also include other removable/non-removable volatile/nonvolatile computer storage media. By way of example only, FIG. 9 illustrates a hard disk drive 841 that reads from or writes to non-removable, nonvolatile magnetic media, a magnetic disk drive 851 that reads from or writes to a removable, nonvolatile magnetic disk 852, and an optical disk drive 855 that reads from or writes to a removable, nonvolatile optical disk 856 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 841 is typically connected to the system bus 821 through a non-removable memory interface such as interface 840, and magnetic disk drive 851 and optical disk drive 855 are typically connected to the system bus 821 by a removable memory interface, such as interface 850.

The drives and their associated computer storage media discussed above and illustrated in FIG. 9, provide storage of computer readable instructions, data structures, program modules and other data for the computer 810. In FIG. 9, for example, hard disk drive 841 is illustrated as storing operating system 844, application programs 845, other program modules 846, and program data 847. Note that these components can either be the same as or different from operating system 834, application programs 835, other program modules 836, and program data 837. Operating system 844, application programs 845, other program modules 846, and program data 847 are given different numbers here to illustrate that, at a minimum, they are different copies.

A user may enter commands and information into the computer 810 through input devices such as a keyboard 862, a microphone 863, and a pointing device 861, such as a mouse, trackball or touch pad. Other input devices (not shown) may include a joystick, game pad, satellite dish, scanner, or the like. These and other input devices are often connected to the processing unit 820 through a user input interface 860 that is coupled to the system bus, but may be connected by other interface and bus structures, such as a parallel port, game port or a universal serial bus (USB), A visual display 891 or other type of display device is also connected to the system bus 821 via an interface, such as a video interface 890. In addition to the monitor, computers may also include other peripheral output devices such as speakers 897 and printer 896, which may be connected through an output peripheral interface 895.

The computer 810 is operated in a networked environment using logical connections to one or more remote computers, such as a remote computer 880. The remote computer 880 may be a personal computer, a hand-held device, a server, a router, a network PC, a peer device or other common network node, and typically includes many or all of the elements described above relative to the computer 810. The logical connections depicted in FIG. 8 include a local area network (LAN) 871 and a wide area network (WAN) 873, but may also include other networks. Such networking environments are commonplace in offices, enterprise-wide computer networks, intranets and the Internet.

When used in a LAN networking environment, the computer 810 is connected to the LAN 871 through a network interface or adapter 870. When used in a WAN networking environment, the computer 810 typically includes a modem 872 or other means for establishing communications over the WAN 873, such as the Internet. The modem 872, which may be internal or external, may be connected to the system bus 821 via the user input interface 860, or other appropriate mechanism. In a networked environment, program modules depicted relative to the computer 810, or portions thereof, may be stored in the remote memory storage device. By way of example, and not limitation, FIG. 8 illustrates remote application programs 885 as residing on remote computer 880. It will be appreciated that the network connections shown are exemplary and other means of establishing a communications link between the computers may be used.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A computer-implemented method of conducting a sales transaction, comprising:
receiving, on a multi-modal interactive surface in a retail store, a first user input requesting pre-sale processing;
generating, on the multi-modal interactive surface, a pre-sale display with a pre-sale user input mechanism that receives user pre-sale inputs;
accessing product information from a retail management system that includes line-of-business components, based on the user pre-sale inputs to obtain the product information;
modifying the pre-sale display on the multi-modal interactive surface based on the user pre-sale inputs and based on the product information;
receiving, on the multi-modal interactive surface, a user sale input indicative of a desired user purchase of a selected product;
generating, on the multi-modal interactive surface, a sales display with user payment input mechanisms for receiving user payment information to facilitate payment for the selected product; and
generating post-sale information for the user with the multi-modal interactive surface.

2. The computer-implemented method of claim 1 wherein generating the pre-sale display comprises:
displaying pre-sale product information for products, the pre-sale user input mechanism including a touch sensitive display screen, the pre-sale user inputs including touch gestures for browsing products.

3. The computer-implemented method of claim 2 wherein displaying pre-sale product information comprises:
displaying a set of pre-sale tiles in a browsing section of the touch sensitive display screen, each pre-sale tile corresponding to a different product and displaying product information describing the corresponding product at a first level of detail.

4. The computer-implemented method of claim 3 the user pre-sale inputs include receiving a change detail touch gesture requesting a change in detail of the product information corresponding to a product for a selected pre-sale tile.

5. The computer-implemented method of claim 4 wherein receiving a change detail touch gesture comprises:
receiving a touch gesture on the selected pre-sale the that indicates a desired change in detail.

6. The computer-implemented method of claim 4 wherein generating the pre-sale display includes displaying a user-movable detail slider and receiving a change detail touch gesture comprises:
receiving a slider touch gesture changing a position of the user movable touch gesture.

7. The computer-implemented method of claim 3 wherein the user pre-sale inputs include a detail touch gesture requesting more detail for a selected product and wherein modifying the pre-sale display comprises:
expanding the pre-sale tile corresponding to the selected product to include product information describing the product at a second level of detail that is greater than the first level of detail.

8. The computer-implemented method of claim 3 wherein receiving the user sale input comprises:
receiving a sale touch gesture indicating a product corresponding to a user-selected pre-sale tile in the browsing section is to be added to a group of products to be purchased by the user.

9. The computer-implemented method of claim $ and further comprising:
displaying a shopping cart area on the touch sensitive display screen; and
displaying a sale tile corresponding each user-selected pre-sale tile, in the shopping cart area of the touch sensitive display screen.

10. The computer-implemented method of claim 9 wherein displaying a sale tile comprises:
displaying the sale tile with a graphic representation of the corresponding product and a quantity indicator indicating a quantity of the corresponding product that is to be purchased.

11. The computer-implemented method of claim 10 and further comprising:
receiving a swipe touch gesture on a sale tile; and
changing the quantity of the corresponding product to be purchased based on a direction of the swipe gesture.

12. The computer-implemented method of claim 10 wherein the multi-modal interactive surface comprises a multi-touch surface and further comprising:
receiving a multi-finger swipe gesture on a sale tile; and
removing the sale tile from the shopping cart area.

13. The computer-implemented method of claim 9 wherein the pre-sale tiles in the browser section comprise a scrollable first set of tiles, scrollable based on scroll touch gestures and wherein the sale tiles in the shopping cart area comprise a scrollable second set of tiles, scrollable based on scroll touch gestures independently of the scrollable first set of tiles.

14. The computer-implemented method of claim 1 wherein generating post-sale information for the user comprises:
sending a location identifier to a mobile device of the user, the location identifier identifying a location in the retail store for each purchased product.

15. The computer-implemented 1 wherein generating post-sale information for the user comprises:
sending route information to a mobile device of the user, the route information showing a route through the retail store for reaching each purchased product.

16. The computer-implemented method of claim 15 wherein sending route information comprises:
tracking the user's location in the retail store; and
updating the route information sent to the mobile device of the user based on the tracked location.

17. The computer-implemented method of claim 1 and further comprising:
performing post-sale processing in at least one of the line-of-business components in the retail management system.

18. The computer-implemented method of claim 17 wherein performing post-sale processing comprises:
updating inventory to reflect products purchased by the user.

19. An interactive device, comprising:
a multi-modal interactive surface;
a user interface component generating user interface displays on, and receiving user inputs from, the multi-modal interactive surface, the user interface component receiving a user browse input and generating a product browsing display on the multi-modal interactive surface and receiving user touch inputs for browsing products, the user interface component further generating a shopping cart display showing products to be purchased by the user, and a checkout display facilitating user payment for the products to be purchased; and
a processor interacting with line-of-business components in a retail management system and with the multi-modal interactive surface and the user interface component to facilitate browsing products and user payment.

20. A computer readable medium having computer executable instructions stored thereon which, when executed by a computer, cause the computer to perform a method of conducting a sales transaction, comprising:
receiving, on a multi-modal interactive surface in a retail store, a first user input requesting pre-sale processing;
generating, on the multi-modal interactive surface, a pre-sale display with a pre-sale user input mechanism that receives user pre-sale inputs, by displaying pre-sale product information for products, the pre-sale user input mechanism including a touch sensitive display screen, the pre-sale user inputs including touch gestures for browsing products;
accessing a retail management system that includes line-of-business components, based on the user pre-sale inputs to obtain product information;
modifying the pre-sale display on the multi-modal interactive surface based on the user pre-sale inputs and based on the product information;
receiving, on the multi-modal interactive surface, a user sale input indicative of a desired user purchase of a selected product;
generating, on the multi-modal interactive surface, a sales display with user payment input mechanisms for receiving user payment information to facilitate payment for the selected product; and
generating post-sale information for the user with the multi-modal interactive surface by sending a location identifier to a mobile device of the user, the location identifier identifying a location in the retail store for each purchased product.
